(19) United States
(12) Patent Application Publication
(10) Pub. No.: US 2026/0090676 A1
(43) Pub. Date: Apr. 2, 2026

(54) AUTOMATED FOOD FRYING SYSTEMS

(71) Applicant: Henny Penny Corporation, Eaton, OH (US)

(72) Inventors: Barney Wragg, London (GB); Joe Muller, London (GB); Peter Schroder, London (GB); Richard Williams, London (GB); Chris Tait, London (GB); Thomas Lambert, London (GB)

(21) Appl. No.: 19/111,637

(22) PCT Filed: Sep. 15, 2023
(86) PCT No.: PCT/US2023/074361

§ 371 Date: Mar. 13, 2025

(30) Foreign Application Priority Data
Sep. 16, 2022 (GB) 2213604.8

(51) Int. Cl. A47J 37/12

(52) U.S. Cl. CPC A47J 37/1228; A47J 37/1266; A47J 37/1276; A47J 37/1295

(57) ABSTRACT

An automated food-fryer system is configured to move a basket from a position at which it can receive food from a frozen food dispenser to a cooking well. The system includes a freezer chamber that includes a twin auger subsystem. The twin auger subsystem is configured to dispense food into the frozen food dispenser.

### TECHNICAL FIELD

This application relates to an automated food frying system.

### BACKGROUND

In commercial kitchens, such as fast-food restaurants, the manual process of frying is often assigned to less experienced kitchen staff, which can lead to subpar fried food due for example to incorrect cooking times or oil temperature variations.

Automating the food frying process can deliver consistent, high-quality results while reducing labor costs and improving staff safety. However, automating the food frying process remains a challenging task.

Automated food frying systems often utilise frozen food as key ingredients. However, a challenge in these systems is the efficient and precise cutting of blocks of frozen food.

Current systems need to be improved in using such ingredients. Additionally, food frying systems also need to adapt to new product and/or ingredient being introduced.

### SUMMARY

An implementation of the invention is an automated food frying system. The system addresses the problems identified earlier and provides new functionality that enhances consumer choice, improves food quality, reduces food wastage and reduces energy consumption.

A first aspect of the invention is an automated food-fryer system that is configured to move a basket from a position at which it can receive food from a frozen food dispenser to a cooking well; in which the system includes a freezer chamber that includes a twin auger subsystem that is configured to dispense food into the frozen food dispenser.

Another aspect is an automated food-fryer system that is configured to move a basket from a position at which it can receive food from a frozen food dispenser to a cooking well; in which the system includes a freezer chamber that is configured to dispense food into the frozen food dispenser; and in which the freezer chamber is entirely removable from the other parts of the system.

Another aspect is an automated food-fryer system that is configured to move a basket from a position at which it can receive food from a frozen food dispenser to a cooking well; the system including a basket transport system that is made up of (i) a main transport subsystem that moves the basket laterally across the system and (ii) multiple vertical transport subsystems that moves the basket vertically across the system between the main transport subsystem.

Another aspect is an automated food-fryer system that is configured to move a basket from a position at which it can receive food from a frozen food dispenser to a cooking well; the system including a vertical transport subsystem that includes a basket shaker mechanism that shakes the basket while the basket is being transported.

Another aspect is an automated food-fryer system that is configured to move a basket from a position at which it can receive food from a frozen food dispenser to a cooking well and then to hot hold zone; in which the system is configured to adjust the temperature of the hot hold zone to a predefined temperature.

Another aspect of the invention is an automated food-fryer system that is configured to move a basket from a position at which it can receive food from a frozen food dispenser to a cooking well; in which the system is configured to automatically adapt to variation in products and/or to new product or ingredient introduced.

Another aspect of the invention is an automated food-fryer system that is configured to move a basket from a position at which it can receive food from a frozen food dispenser to a cooking well; in which the system includes an oil measurement subsystem that is configured to monitor oil related parameter in the cooking well.

Another aspect is an automated food-fryer system that is configured to move baskets from a position at which it can receive food from a frozen food dispenser to cooking wells; in which the system includes segregated cooking wells or baskets for dietary requirements or allergens.

Another aspect is a remote management system that organises multiple food fryer systems at different locations, in which each food fryer system is an automated food-fryer system that is configured to move baskets from a position at which it can receive food from a frozen food dispenser to cooking wells.

### BRIEF DESCRIPTION OF THE FIGURES

The following figures show features of the food-fryer system according to embodiments of the present invention.

FIG. 1 is a general view of the exterior of the food-fryer system.

FIG. 2 is a front view of the exterior of the food-fryer system.

FIG. 3 is an interior view of the food-fryer system.

FIG. 4 is a general view of the exterior of the food-fryer system, including an autopacking unit.

FIG. 5 is a perspective view showing a frozen food compartment dispensing food into a frying basket.

FIG. 6 is a perspective view showing the basket transport system.

FIG. 7 is a perspective view showing a basket tipping fries into the food dump.

FIG. 8 is a perspective view showing a basket being manually loaded into the system.

FIG. 9 is a perspective view showing the frozen food dispenser being removed from the system for maintenance.

FIG. 10 is a perspective view showing the fryer unit being removed from the system for maintenance.

FIG. 11 is a perspective view showing a different variant of the food-fryer system, made up of three separate units.

FIG. 12 is a front view showing a different variant of the food-fryer system, made up of a single unit.

FIG. 13 is a schematic view of the process flow through the unit shown in FIG. 12.

FIG. 14 is a front view of the exterior of the system.

FIG. 15 is a perspective view of the system.

FIG. 16 is a perspective view of the cold chamber, hot-hold and basket storage areas, when the cold chamber is inside the system.

FIG. 17 is a top view of the cold chamber, hot-hold and basket storage areas, when the cold chamber is inside the system.

FIG. 18 is a side view of the cold chamber, hot-hold and basket storage areas, when the cold chamber is inside the system.

FIG. 19 is a perspective view of the cold chamber, hot-hold and basket storage areas, when the cold chamber is moved out the system.

FIG. 20 is a top view of the cold chamber, hot-hold and basket storage areas, when the cold chamber is moved out the system.

FIG. 21 is a perspective view of the cold chamber, hot-hold and basket storage areas, when the cold chamber is moved out the system and with the top of the cold chamber removed.

FIG. 22 is a top view of the cold chamber, hot-hold and basket storage areas, when the cold chamber is moved out the system and with the top of the cold chamber removed.

FIG. 23A is a view of the cold chamber.

FIG. 23B is a cross section view of the cold chamber of FIG. 23A along line A-A.

FIG. 24A is a perspective view of the food dispenser mounted on a load cell.

FIG. 24B is a top view of the food dispenser of FIG. 24A.

FIG. 24C is an end view of the food dispenser of FIG. 24A.

FIG. 25A is a perspective view of the food dispenser with the bomber-style doors closed.

FIG. 25B is an end view of the food dispenser of FIG. 25A.

FIG. 26A is a perspective view of the food dispenser with the bomber-style doors open.

FIG. 26B is an end view of the food dispenser of FIG. 26A.

FIG. 27 is a perspective view of the main transport including a fryer gripper.

FIG. 28 is a front view of the main transport including a fryer gripper.

FIG. 29 is a perspective view of the main transport including a fryer gripper that securely holds a basket.

FIG. 30 is a front view of the main transport including a fryer gripper that securely holds a basket.

FIG. 31A is a side view showing a fryer gripper securely holding a basket.

FIG. 31B is a perspective view of the fryer gripper and basket of FIG. 31A.

FIG. 32A is a perspective view showing a fryer gripper.

FIG. 32B is an end view of the fryer gripper of FIG. 32A.

FIG. 32C is a bottom perspective view of the fryer gripper of FIG. 32A.

FIG. 33A is a perspective view showing an inverted U-shaped side channel of the fryer gripper.

FIG. 33B is an end view showing the fryer gripper of FIG. 33A.

FIG. 34 is a perspective view of the fry lift shaker subsystem.

FIG. 35 is a side view of the fry lift shaker subsystem.

FIG. 36 is a perspective view of the fry lift shaker subsystem.

FIG. 37 is a side view of the fry lift shaker subsystem.

FIG. 38 is a perspective view of the fry lift shaker subsystem securely holding a basket.

FIG. 39 is a side view of the fry lift shaker subsystem securely holding a basket.

FIG. 40 is a perspective view of the fry lift shaker subsystem securely holding a basket and causing the basket to pivot upwards and then downwards.

FIG. 41 is a side view of the fry lift shaker subsystem securely holding a basket and causing the basket to pivot upwards and then downwards.

FIG. 42 is a perspective view the vertical transport subsystem including basket belt(s) with basket gripper(s).

FIG. 43 is a front view the vertical transport subsystem including basket belt(s) with basket gripper(s).

FIG. 44 is a flowchart diagram illustrating further integration function of the system.

FIG. 45 is a diagram illustrating a continuous system.

FIG. 46 is a diagram illustrating a continuous system.

### NUMBERING INDEX

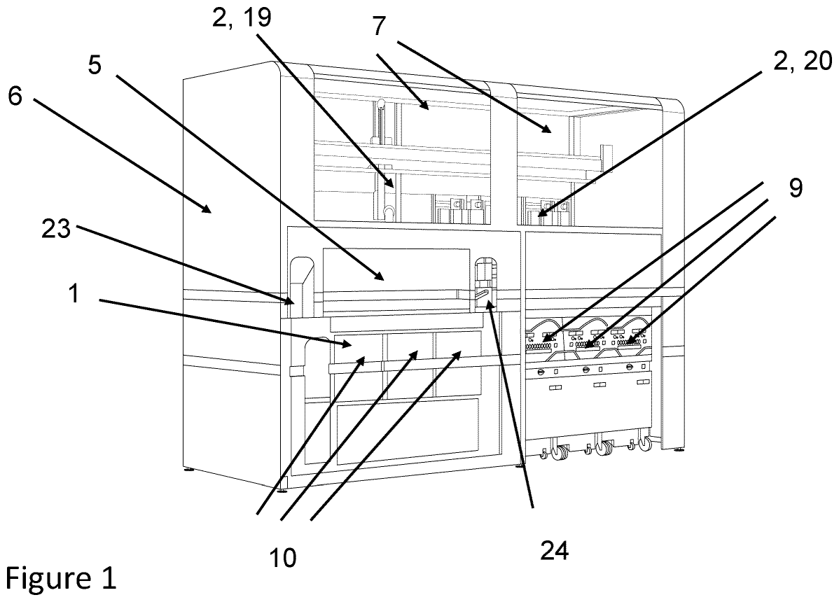

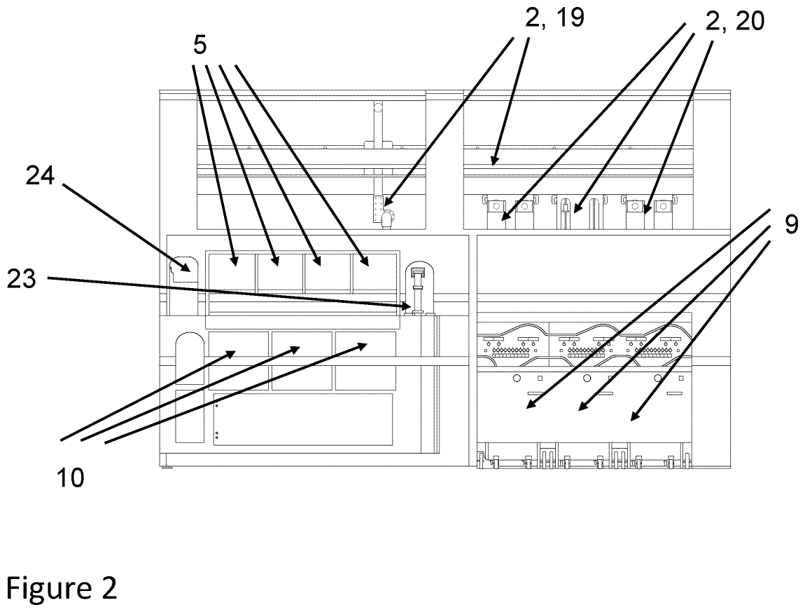

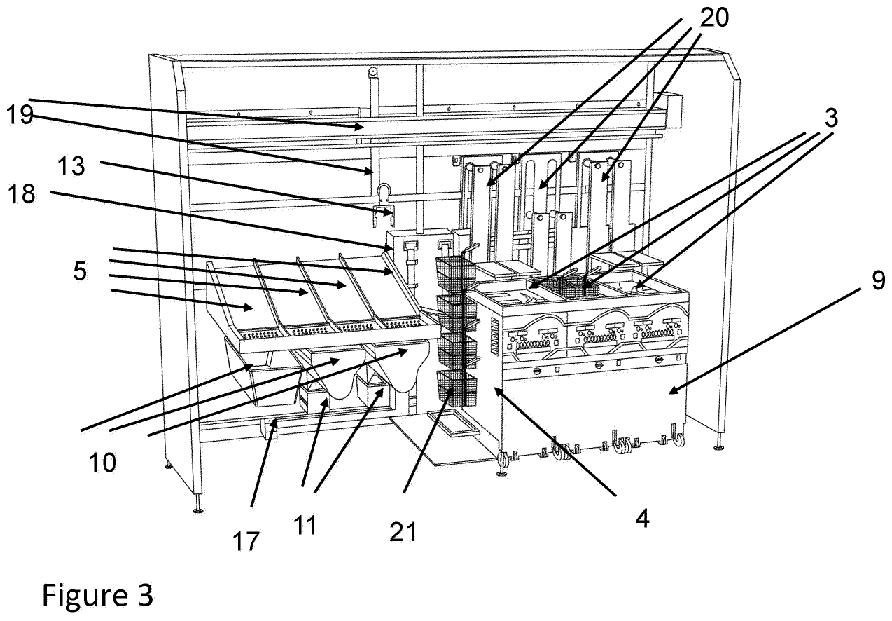

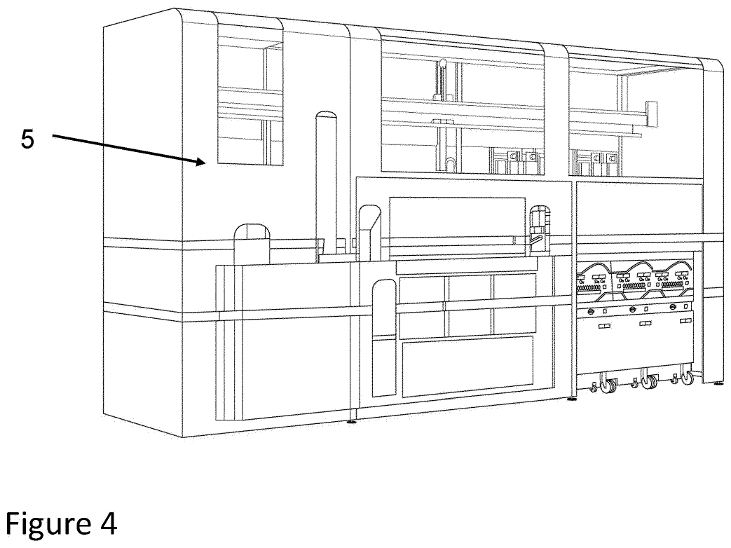

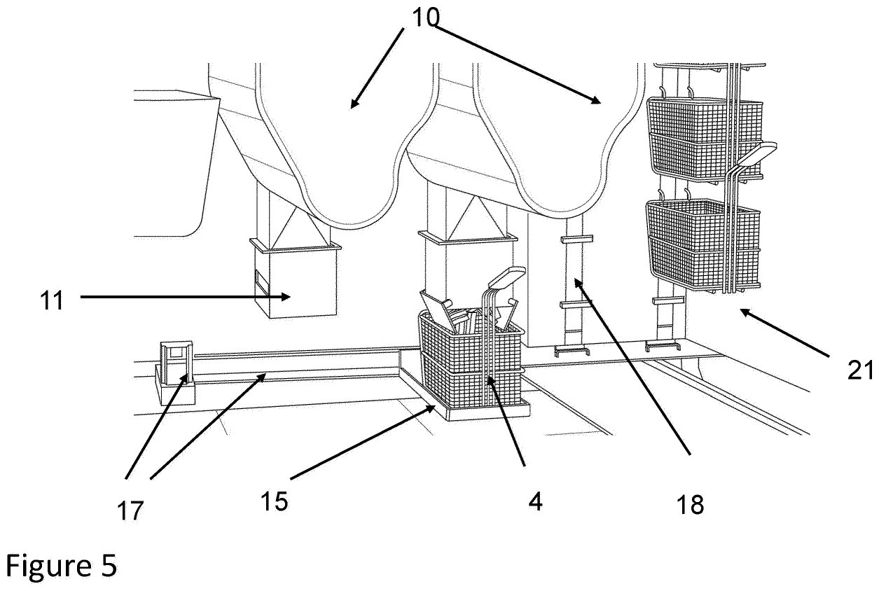

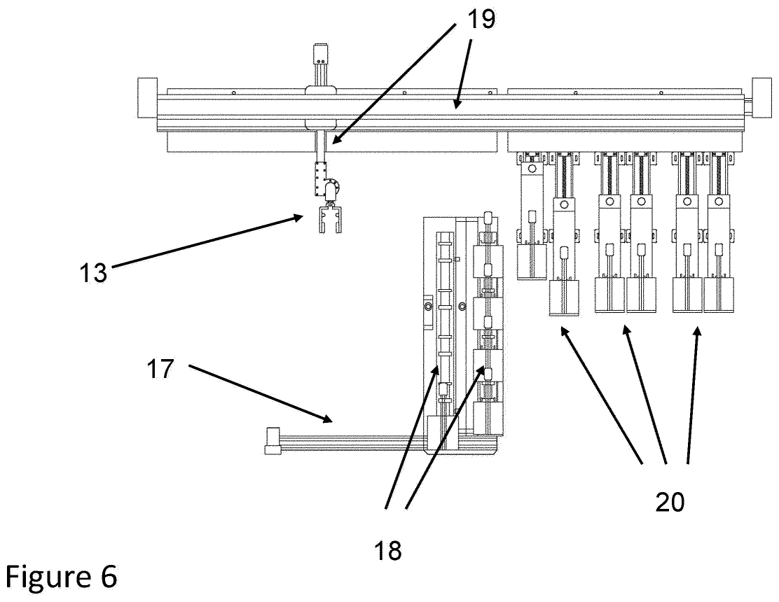

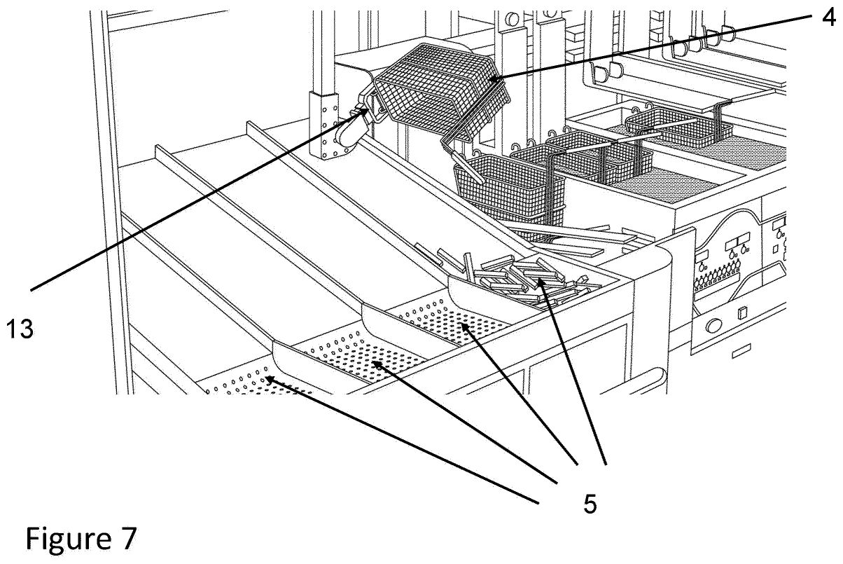

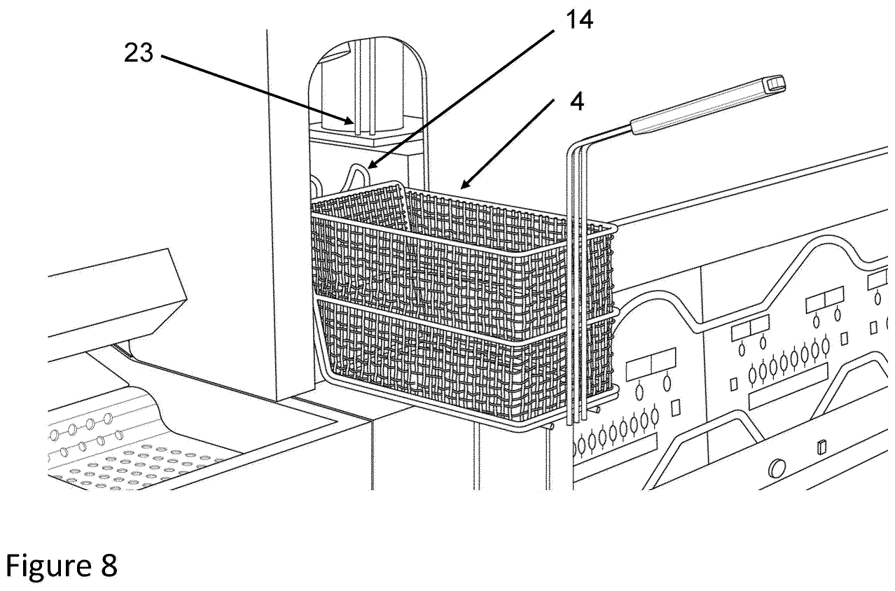

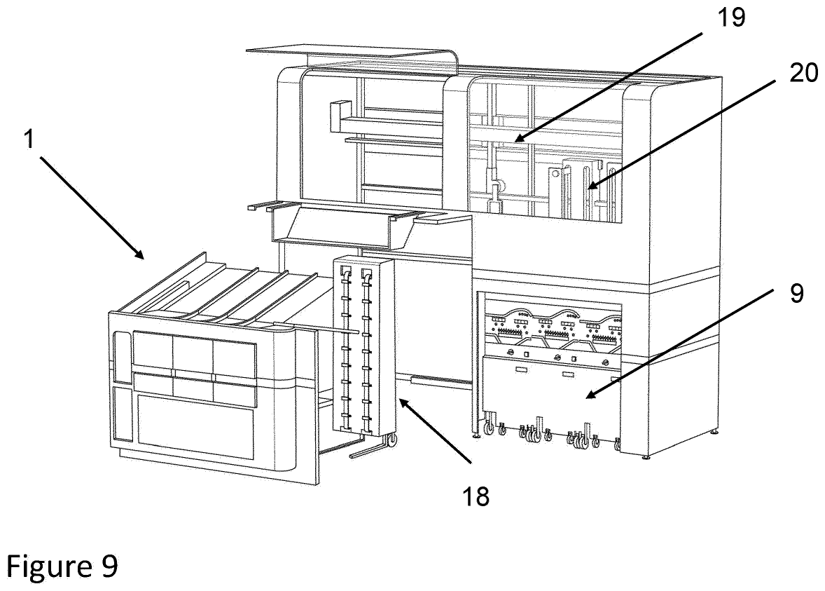

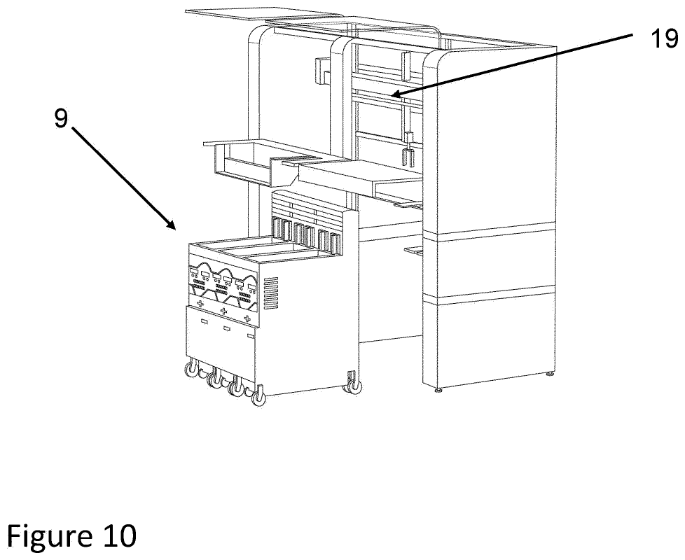

Features in the frying system shown in FIGS. 1-10
Food dispenser (generally frozen food) 1
Transport system 2
Cooking well 3
Fryer basket 4
Food dump 5
Guarding 6
Glazed panels 7
Autopacking unit 8
Fryer unit 9
Frozen food compartment 10
Food exit 11
Basket gripper 13
Basket mounting hook 14
Fryer basket tray 15
Dispenser transport module 17
Link transport module 18
Main transport module 19
Well lifting transport module 20
Basket store 21
Manual basket inlet 23
Manual basket outlet 24

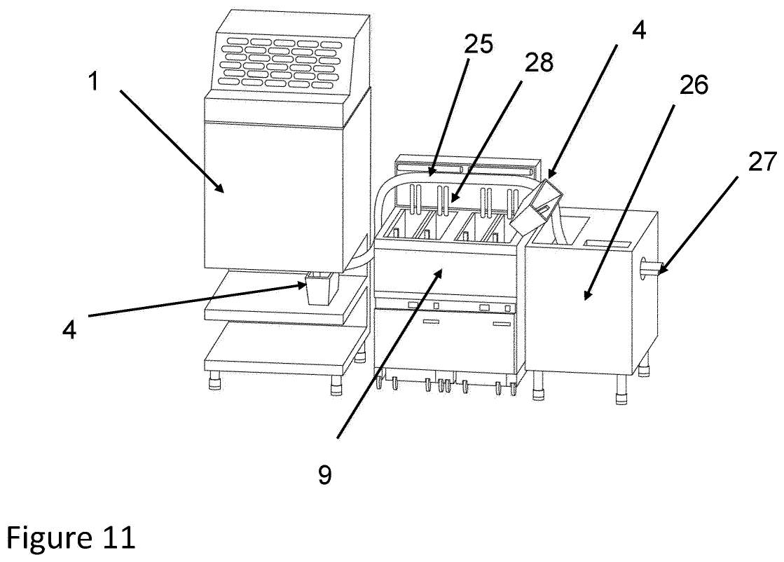

Features in the food frying system shown in FIG. 11
Single transport rail 25
Seasoner unit 26
Seasoner unit food outlet 27
Well transport 28

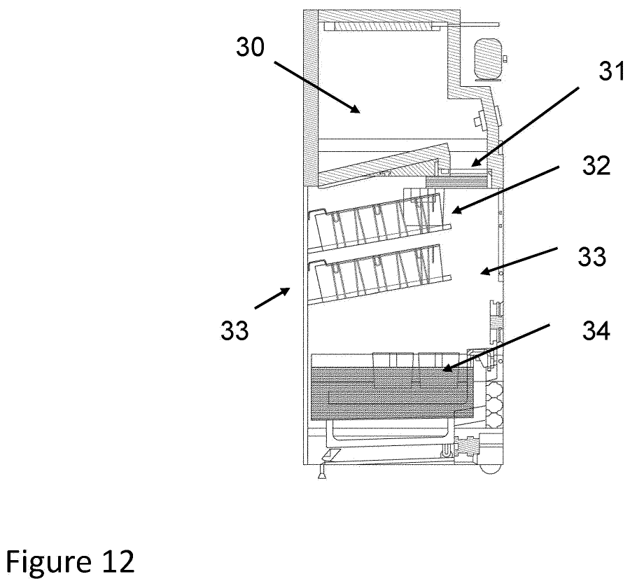

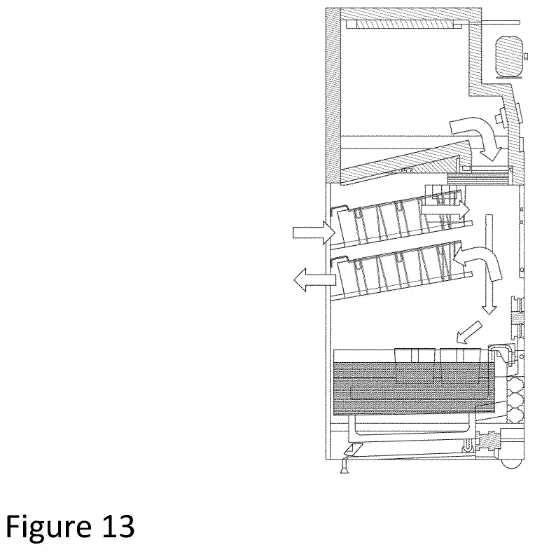

Features in the food frying system shown in FIGS. 12 and 13
Freezer dispenser 30
Portioning system 31
Empty baskets waiting to be filled 32
Vertical basket transport system 33
Fryer wells 34
Baskets with cooked food 33

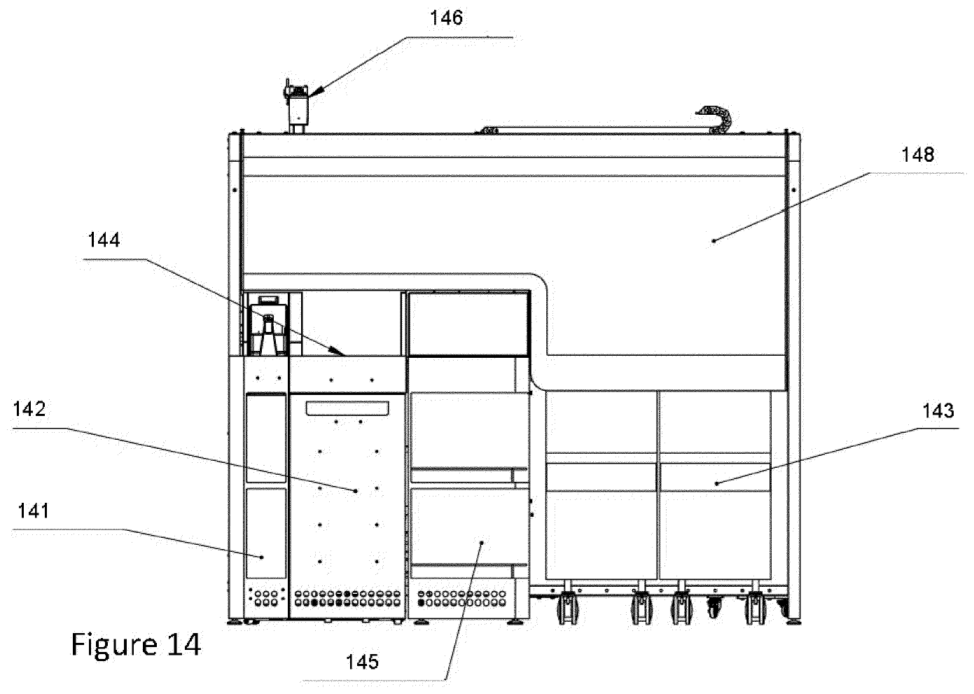

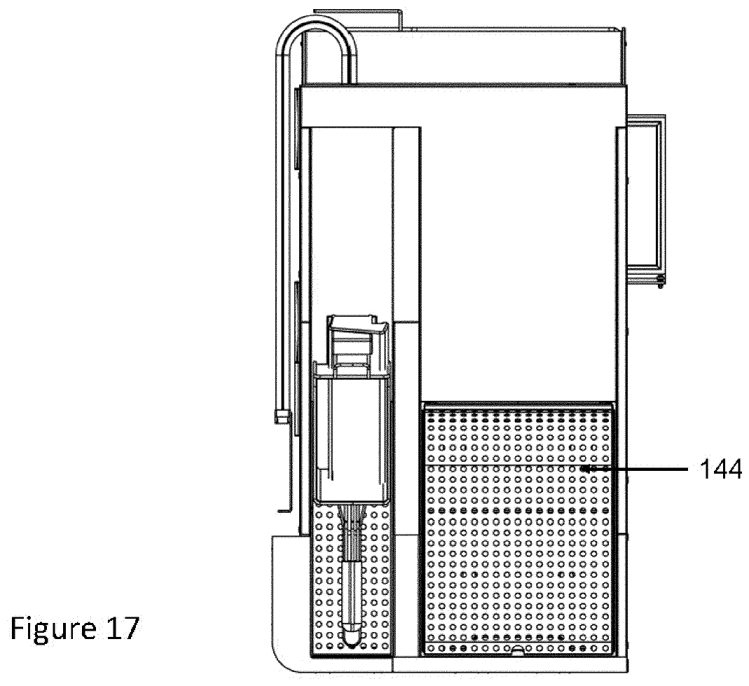

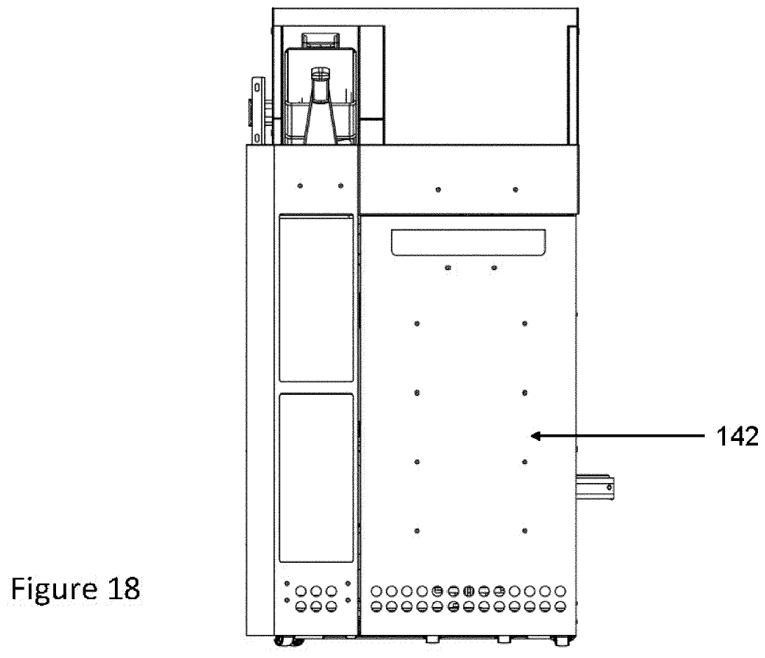

Features in the frying system shown in FIGS. 14-46
Basket storage 141
Freezer or cold chamber 142
Fryer(s) 143
Hot hold 144
Packaging storage 145
Main transport 146
Vertical transports 147
Fry lift shaker 148
Twin augers 210
Bomber-style doors 260
Fryer gripper 270
Basket 290
Inverted U-shaped side channels 300
Holder 340
Vertical track 341
Profiled feature 342
Baskets 452
Belts 453
Wells 454
Conveyor 455

### DETAILED DESCRIPTION

This Detailed Description section covers the food frying system. Note that we start this description section with FIG. 14 because FIGS. 1-13 are related to Appendix A, which is a reproduction of PCT/GB2022/050709 and is provided in detail below. The further disclosures in this section build upon those from the system in FIGS. 1-13.

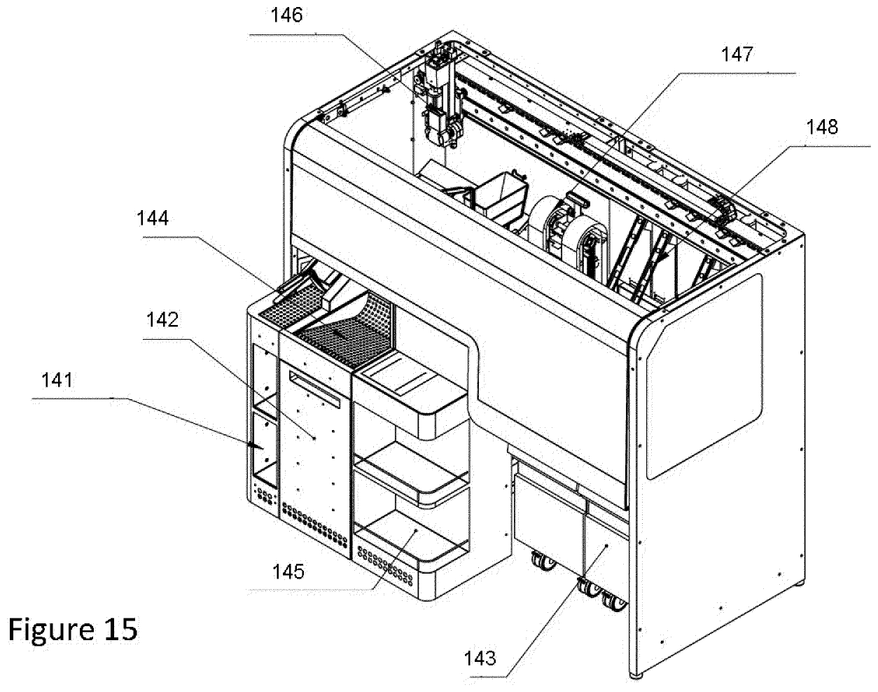

FIGS. 14 and 15 show a front view and perspective view of the exterior of the system. The main parts or areas of the system are: basket storage 141, freezer or cold chamber 142, fryer(s) 143, hot hold 144, packaging storage 145, main transport 146, vertical transports 147 and fry lift shaker 148. Cooled air is blown into the zone that holds the frozen fries; there is a closed loop air recirculation system for this cooled air; this prevents the cold chamber 142 from icing up.

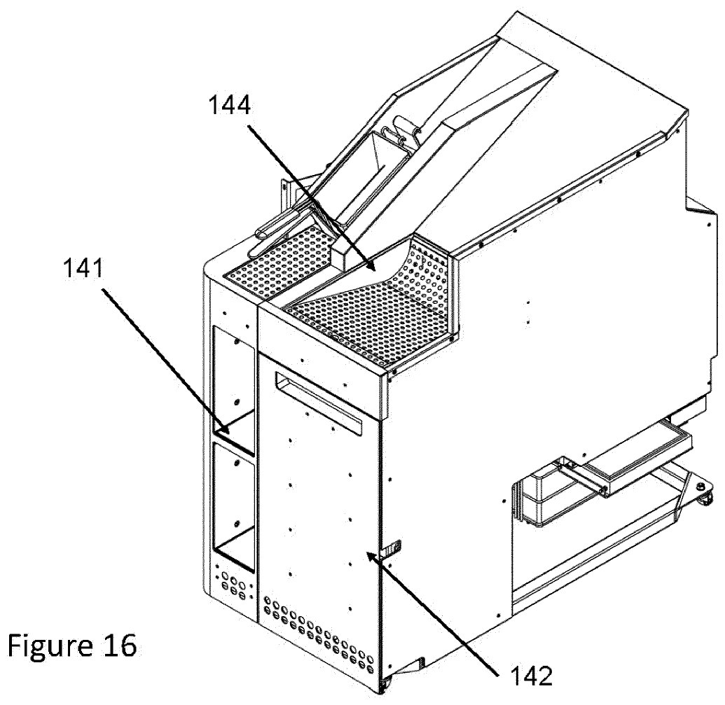

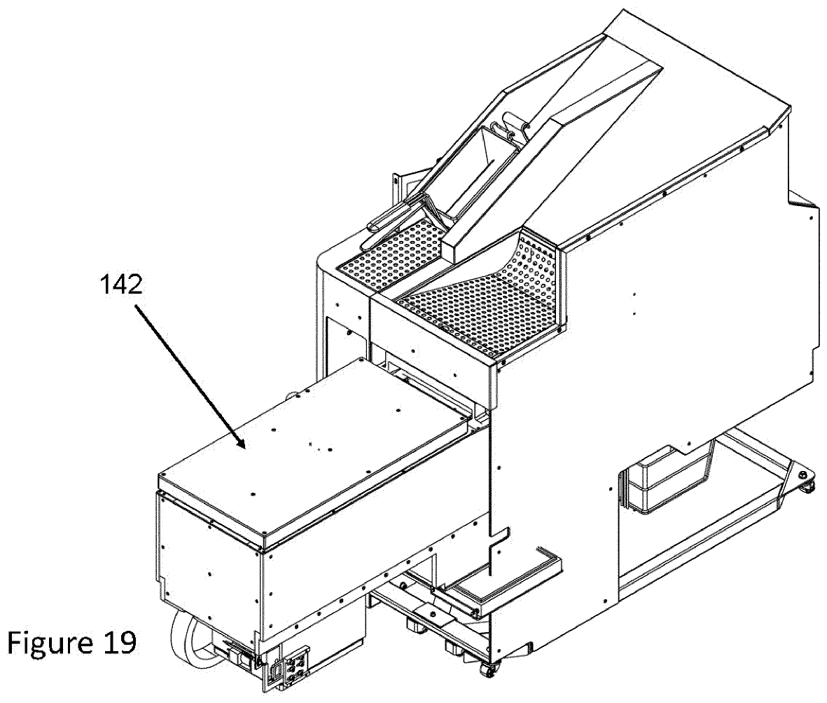

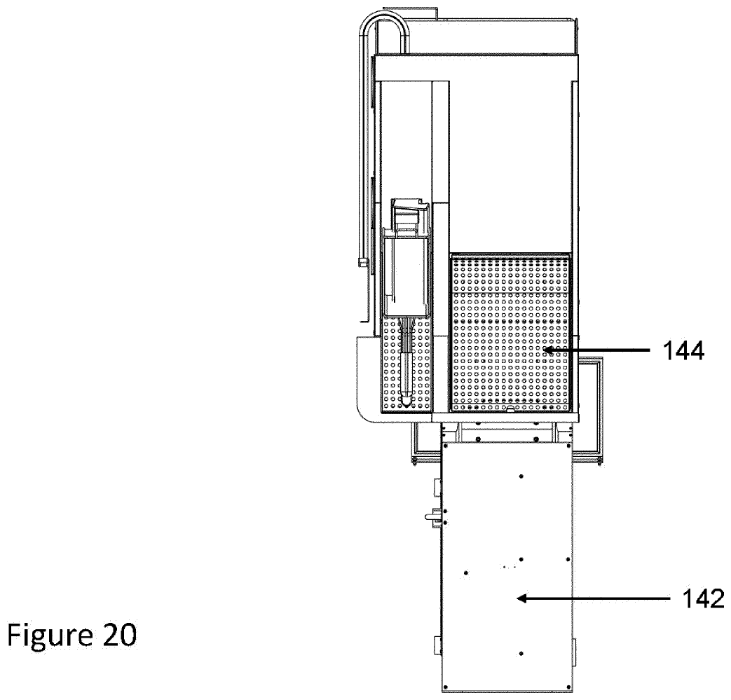

The cold chamber 142 is mounted on rails, enabling the entire cold chamber to be moved out of the system (e.g., to replenish the fries in the chamber) and then pushed back into the system. The motor(s) for the augurs are positioned outside the cold chamber. FIGS. 16-18 show a perspective view, top view, and side view of the cold chamber 142, hot-hold 144 and basket storage areas 141, when the cold chamber is inside the system. FIGS. 19 and 20 show a perspective view and top view of the cold chamber 142, hot-hold 144 and basket storage areas 141, when the cold chamber is moved out the system.

The main transport 146 moves the basket laterally across the system and the vertical transports (e.g., vertical transport 147) moves the basket vertically across the system between the main transport subsystem and cooking well(s).

Alternative footprints or configurations are also possible. For example, freezer or cold chamber may be located behind a frying area, or at 90 degrees in relation to the frying area. For example, other footprints or configurations are provided in FIGS. 1-13.

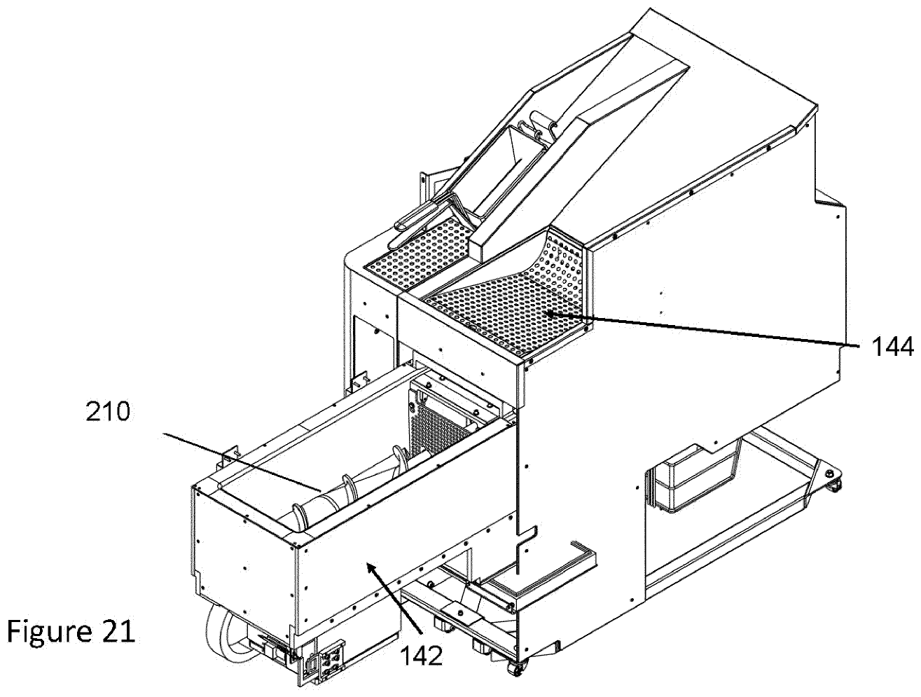

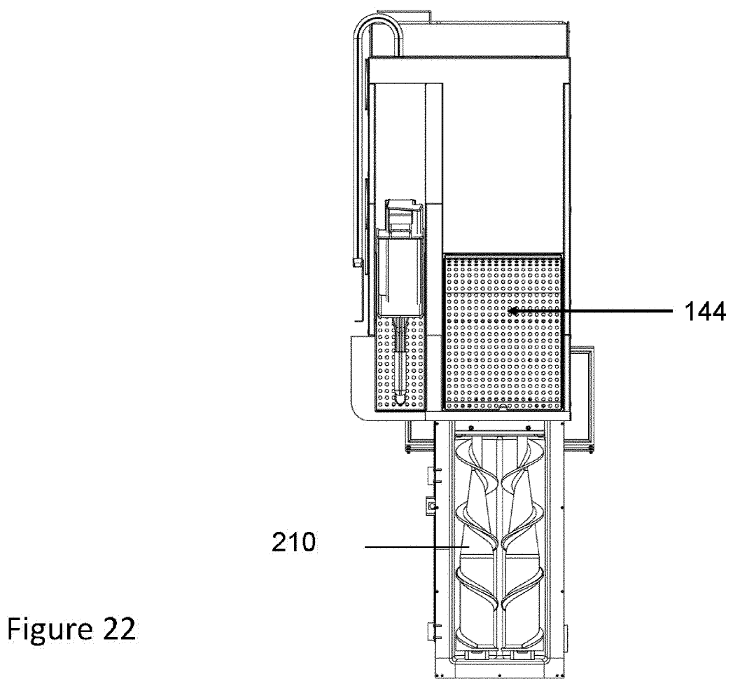

FIGS. 21 and 22 shows a perspective view and top view of the cold chamber 142, hot-hold 144 and basket storage areas 141, when the cold chamber is moved out the system and with the top of the cold chamber removed. Twin augers 210 are located inside the cold or frozen food chamber 142.

As discussed above, cutting blocks of frozen food in automated cooking systems is a challenging task, due to the hardness and brittleness of frozen ingredients. To overcome these challenges, the freezer chamber includes one or more augers. Preferably, a twin auger subsystem is used, as shown in the Figures. Advantageously, the twin auger subsystem is designed to reduce the strain on the cutting blades of the auger, as well as to ensure consistent results and minimize blade wear.

The twin augers 210 in the frozen food chamber 142 counter-rotate, with opposing tines moving together to minimise food jamming.

A drive mechanism is used to control the rotational speed and/or direction of each auger to control the rate and volume of food dispensed.

An algorithm can be used to control the twin auger subsystem, in which the algorithm is configured to adjust rotational speed and/or direction of the first auger and/or second auger to control the rate and volume of food dispensed. The system may employ real-time monitoring and feedback to adjust the control of the twin auger subsystem and to ensure consistent result and minimize blade wear.

The augers may implement different forward/backward rotation algorithms in order to improve dispensing accuracy. As an example, augers rotate for two steps in the forward direction and then one in the backwards direction. The augers taper with a slope designed to optimize the gradual shearing of blocks of frozen fries into individual fries so that, when the frozen fries reach the end of the taper, positioned above the exit doors, then they are separated into individual fries.

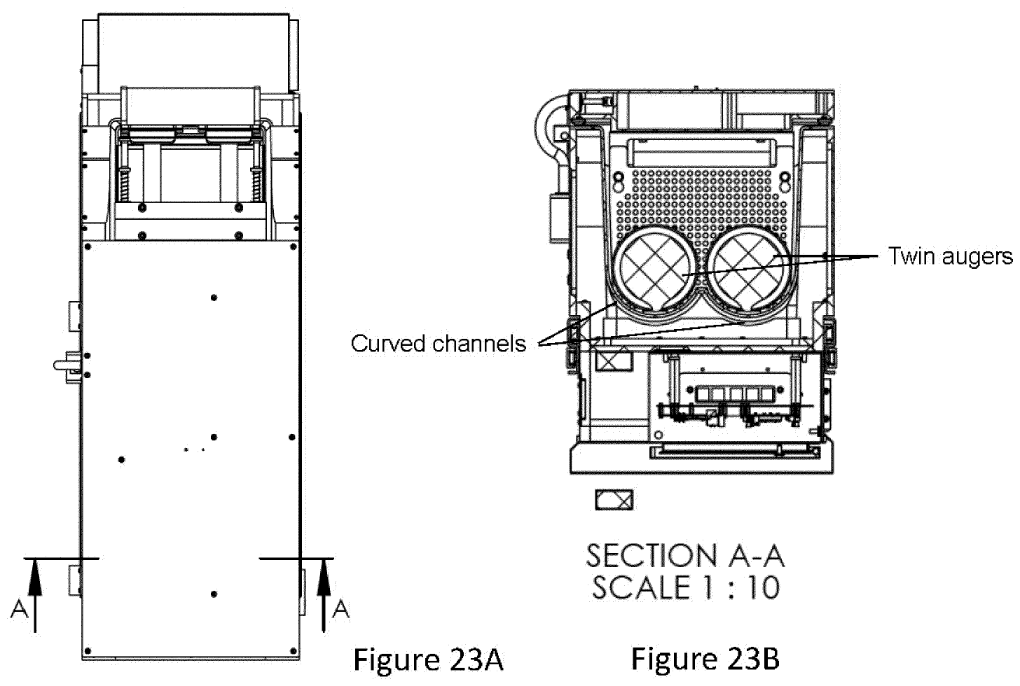

FIGS. 23A and 23B show a cross section of the cold chamber. Each augur is positioned over a curved channel, running parallel to the augur.

Alternatively, the freezer chamber may also be equipped with one or more interchangeable freezer hoppers and/or drawers. The drawer may be designed such that it doesn't extend into walkways. Each drawer can be equipped with a lift flap or a similar mechanism. Each drawer can also be equipped with one or more augers.

The freezer chamber may also be shaped to incorporate different type of food, with each drawer occupying a separate zone with its own auger subsystem (including one or more augers). For instance, two different products can be accommodated within a single drawer, each taking up half of the available space, separated by a central divider. This setup maintains a single timing hopper for consistent output. In such a configuration, the drawer is connected to a split hot hold chute.

The freezer chamber may also include different drawers, which can vary in size to accommodate different types of food.

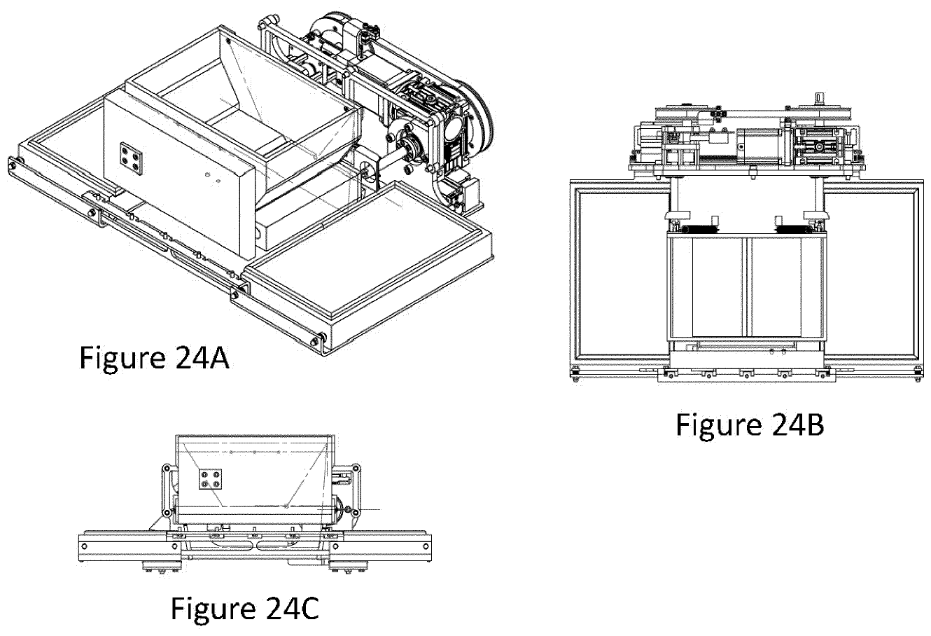

FIGS. 24A-C show different views of the frozen food dispenser mounted on a load cell. The augers deliver food into the frozen food dispenser that is mounted on a load cell; the load cell feeds a control circuit that controls the auger rotation. The food dispenser and load cell, as well as the augers and the frozen food chamber, are all inside a cold unit.

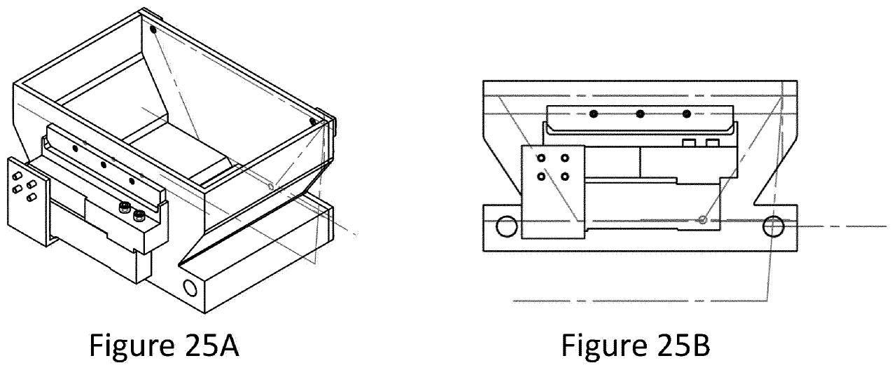

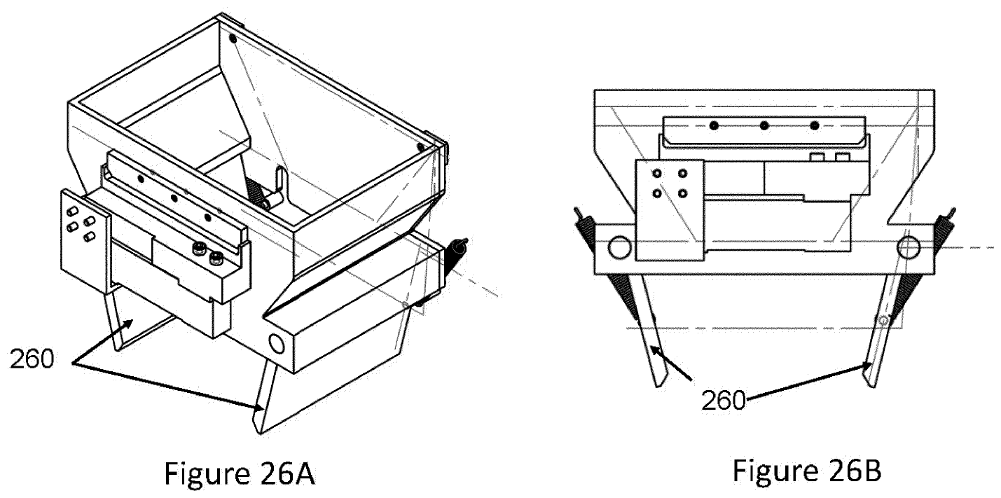

FIGS. 25A and 25B show different views of the food dispenser with the bomber-style doors closed. FIGS. 26A and 26B show different views of the food dispenser with the bomber-style doors open 260.

The food dispenser includes bomber-style doors 260 that pivot open; a sliding insulated cold chamber door sits under the bomber-style doors and is opened prior to the bomber-style doors opening. The food dispenser empties frozen food directly into a fried basket sitting under the opening made by the bomber-style doors. The food dispenser has a sensor on a door that seals the cold chamber to confirm that door has sealed properly (e.g., and no chips are stuck there preventing the door from closing and hence letting warm air into the cold chamber). The sensor gives telemetry signal to enable rapid fault finding if the door is not closing properly.

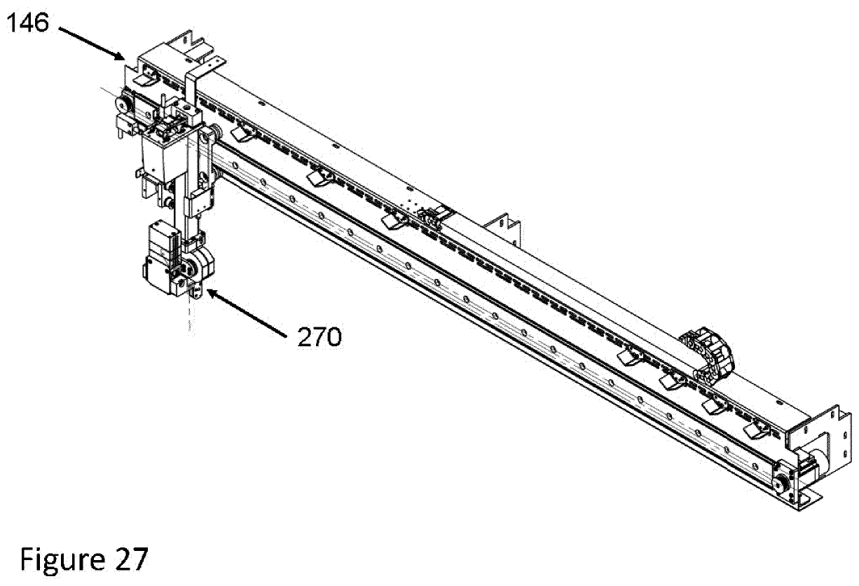

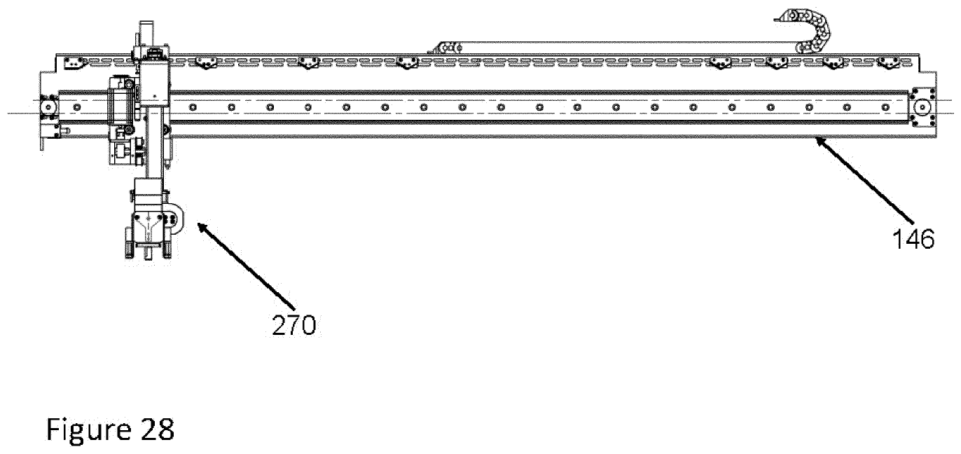

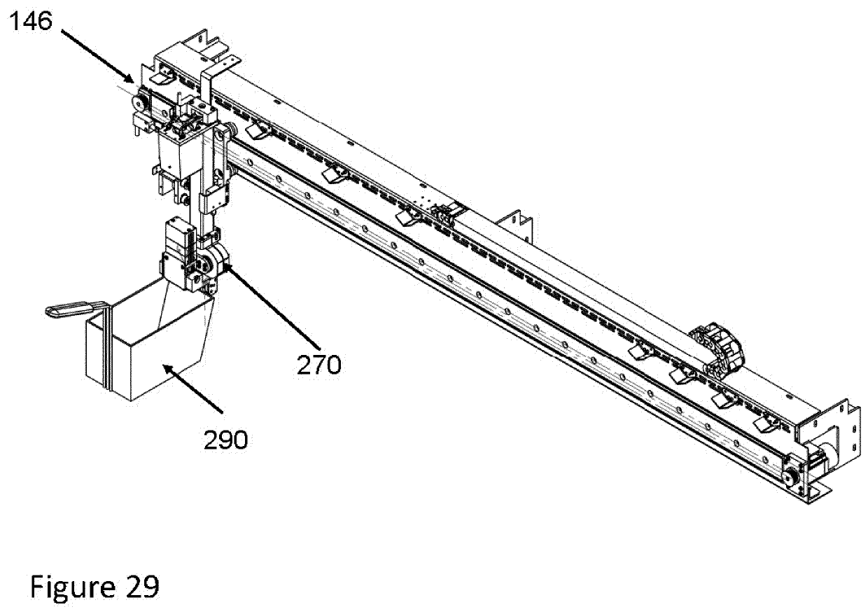

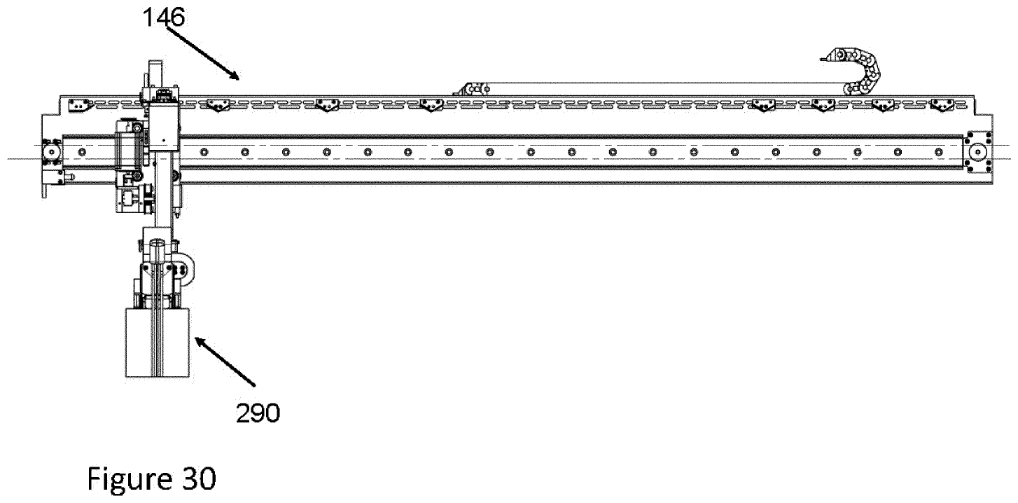

FIGS. 27 and 28 show a perspective view and front view of the main transport 146 including a fryer gripper 270. FIGS. 29 and 30 show a perspective view and front view of the main transport 146 including a fryer gripper 270 that securely holds a basket 290. The fryer basket 290 is gripped and moved laterally across the device using a basket gripper 270.

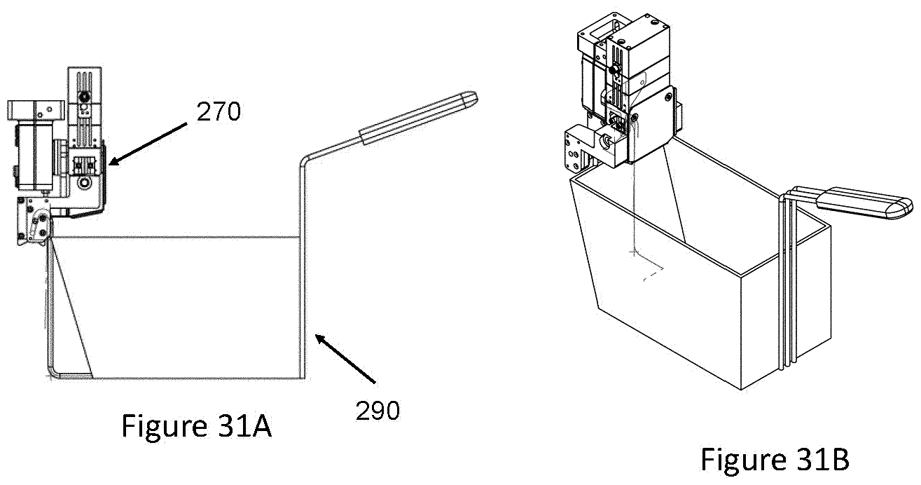

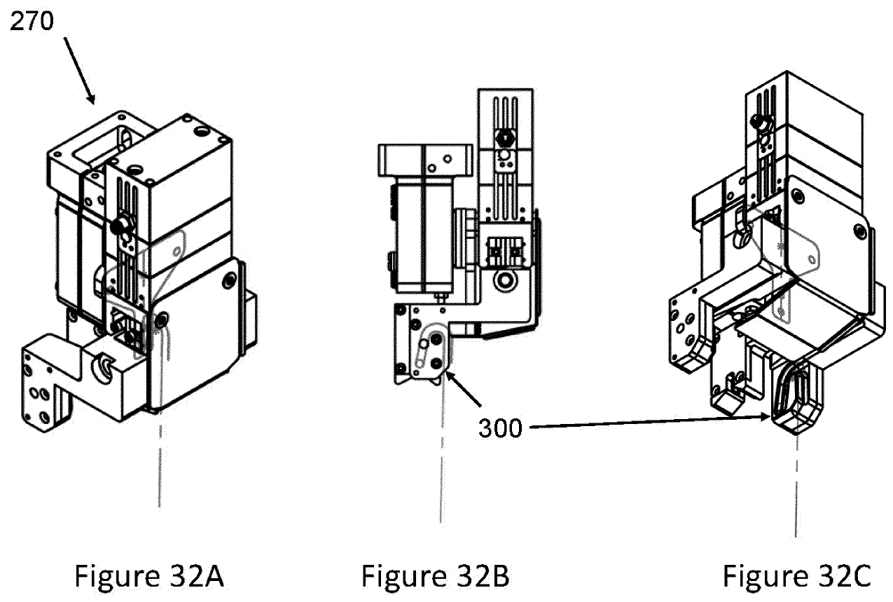

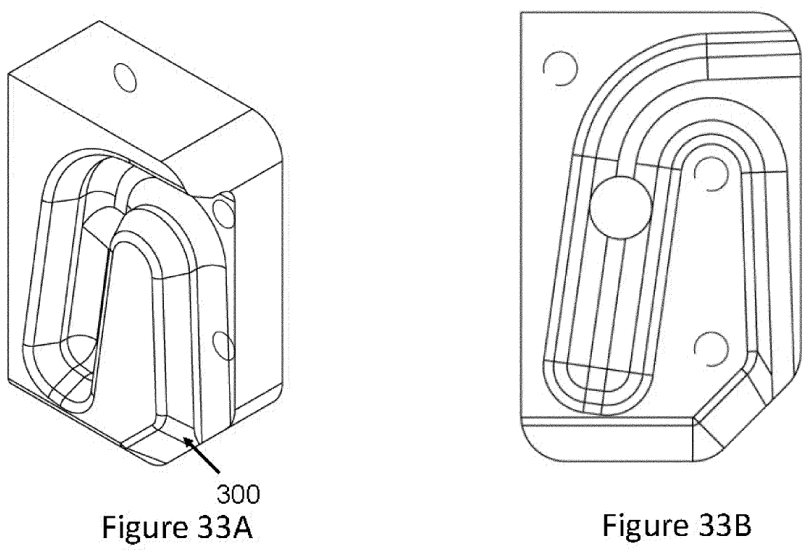

FIGS. 31A-C show a fryer gripper securely holding a basket. The hook on a standard fryer basket has left and right side inverted U-shaped side bars, connected by a horizontal bar. Hence the fryer gripper is configured to securely hold the basket and comprises inverted U-shaped side channels 300. FIGS. 32A and 32B show a fryer gripper. FIGS. 33A and 33B show an inverted U-shaped side channel of the fryer gripper. The basket hook is secured by a gripper with (a) a horizontal channel into which the horizontal bar engages to center and align the gripper and (b) left and right sides, each with channels into which the left and right side inverted U-shaped side bars engage; the left and right sides of the gripper configured to open around the side bars and to close against those side bars.

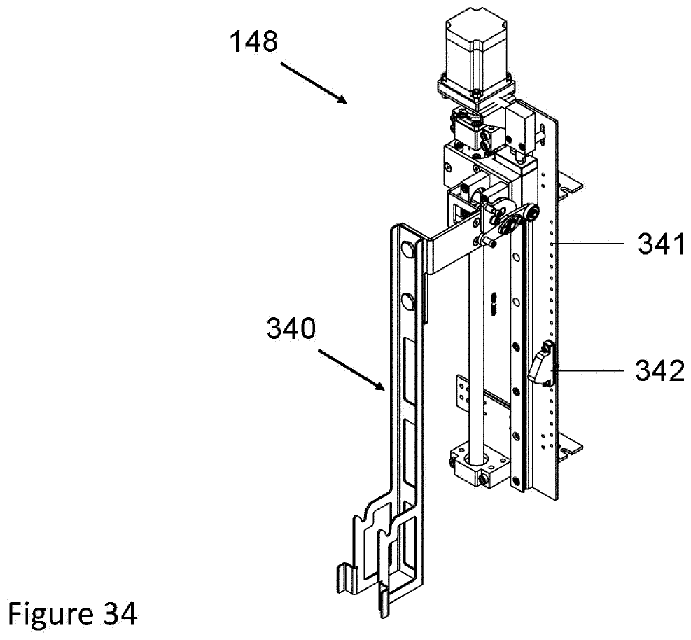

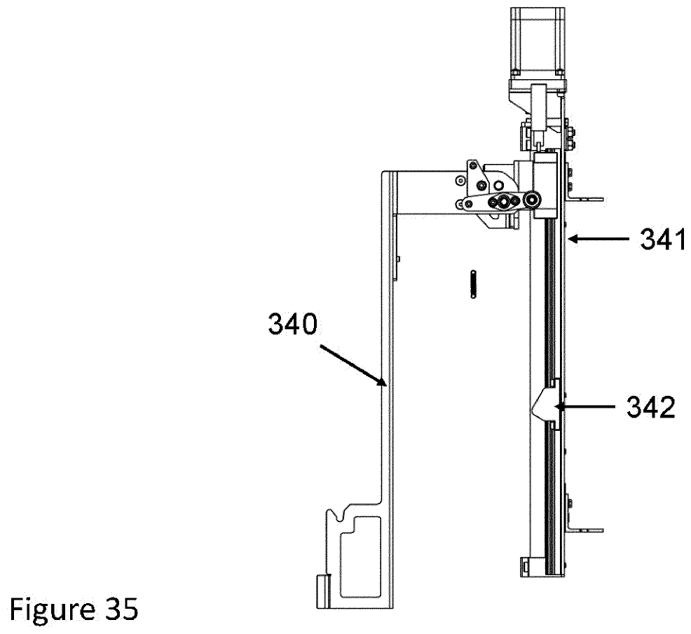

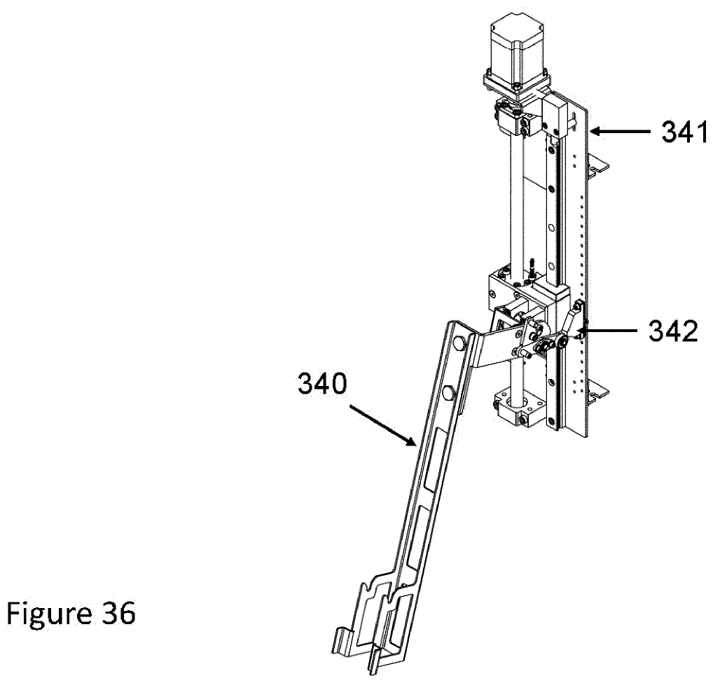

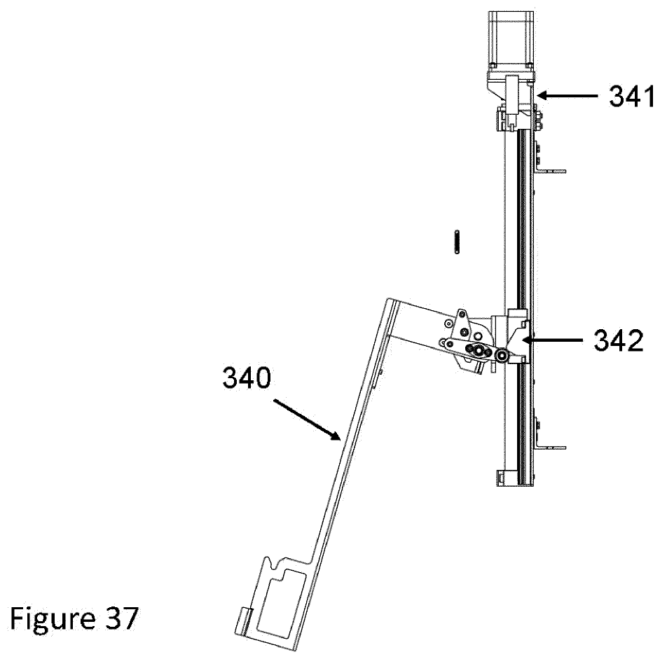

FIGS. 34 and 35 show a perspective view and side view of the fry lift shaker subsystem 148. The holder 340 is flexibly mounted on a vertical track 341 and can move upwards and downwards. The holder is also pivotally mounted on the vertical track, and can therefore pivot upwards and downwards, as shown in FIGS. 36 and 37.

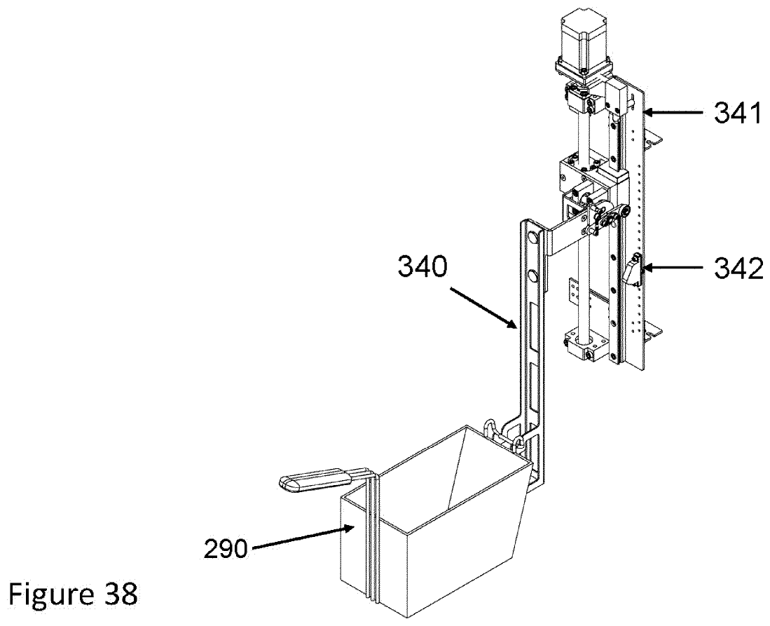

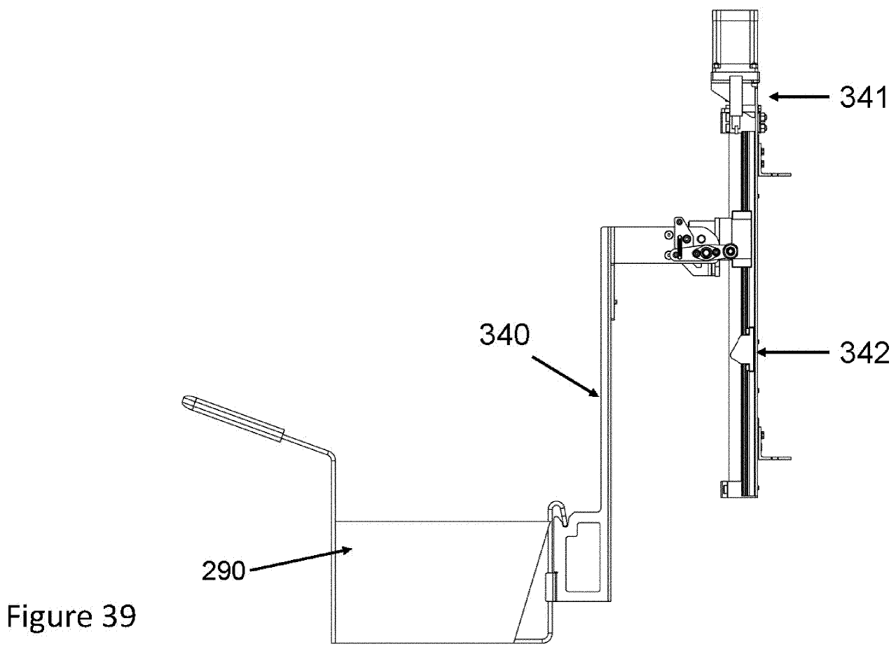

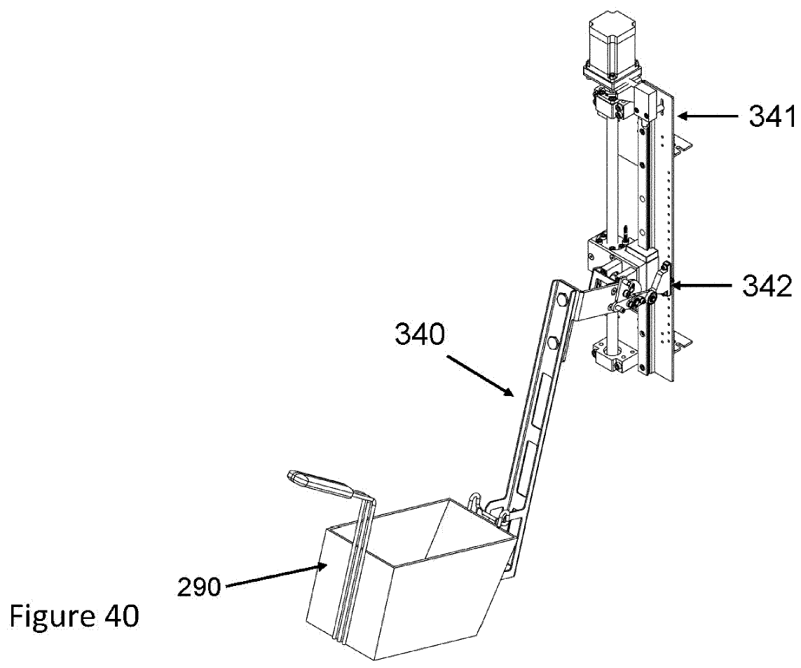

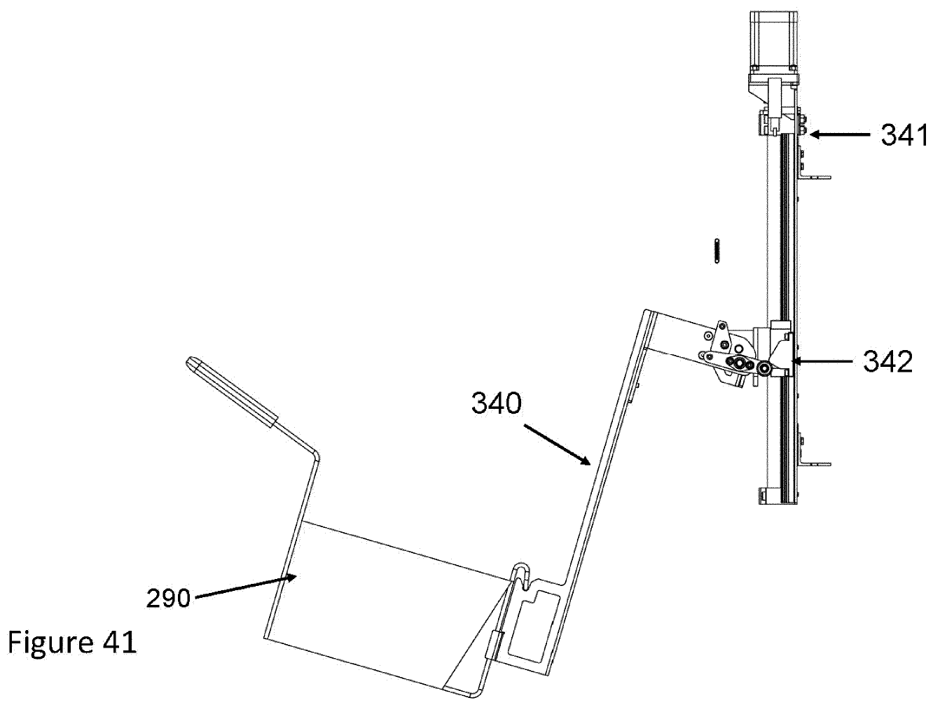

FIGS. 38 and 39 show different views of the fry lift shaker subsystem securely holding a basket. FIGS. 40 and 41 show different views of the fry lift shaker subsystem securely holding a basket and causing the basket to pivot upwards and then downwards. The basket is mounted on a holder that moves up from the frying chamber along a vertical track; as the holder rides up over a profiled feature 342 in the vertical track 341, the holder pivots upwards and then downwards, causing the basket to also pivot upwards and then downwards, giving its contents a shake to remove excess oil from fried food in the basket. The holder can ride up over several profiled features, in each case giving the basket a shake.

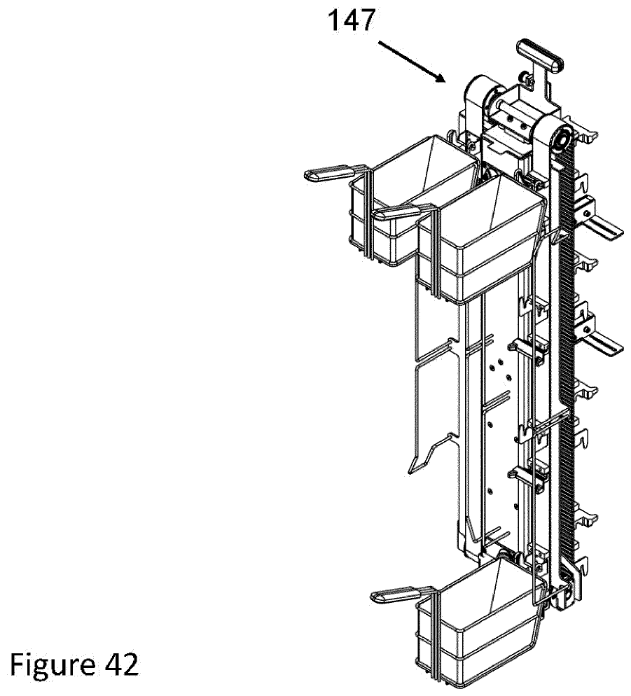

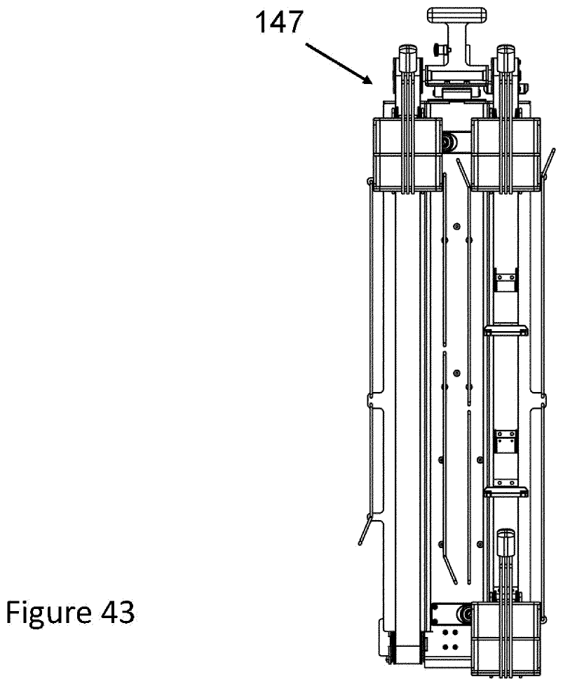

FIGS. 42 and 43 shows a perspective view the vertical transport 147 subsystem including basket belt(s) with basket gripper(s). The basket belt can be removed from its drive mechanism for cleaning. The basket belt that lowers the fryer basket between the main transport working height and the dispenser outlet height includes a gripper with a horizontal channel into which the horizontal bar of the hook on the standard fryer basket engages.

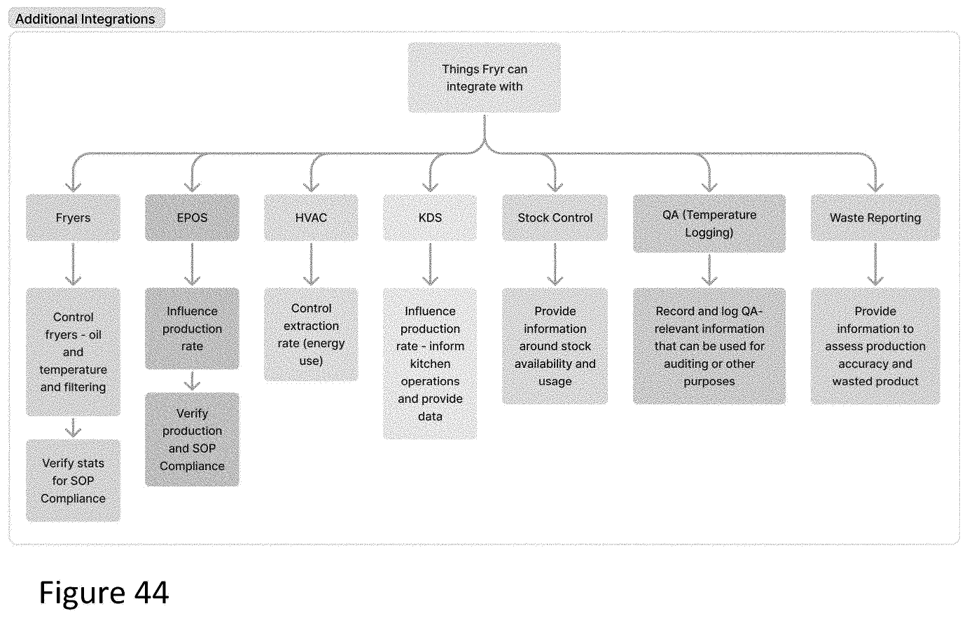

FIG. 44 shows a diagram illustrating further integration function of the system.

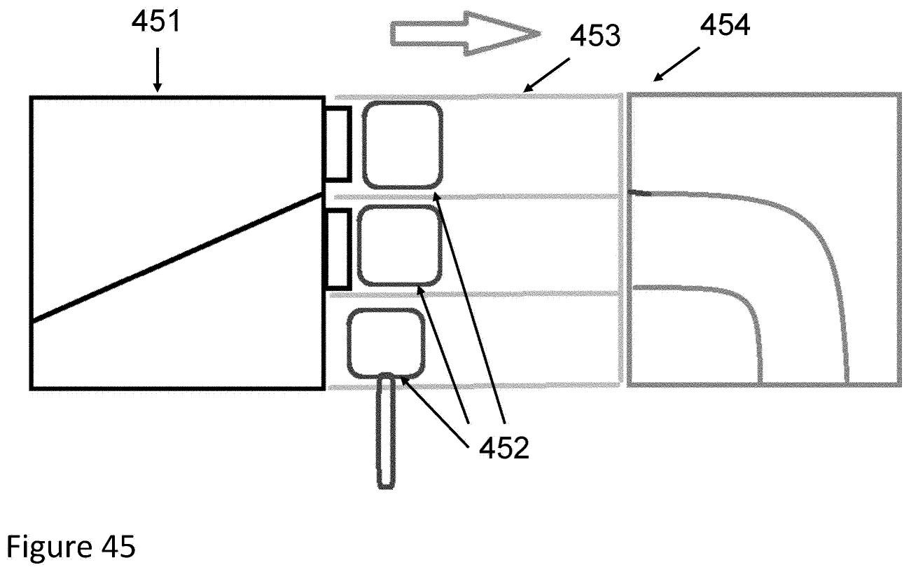

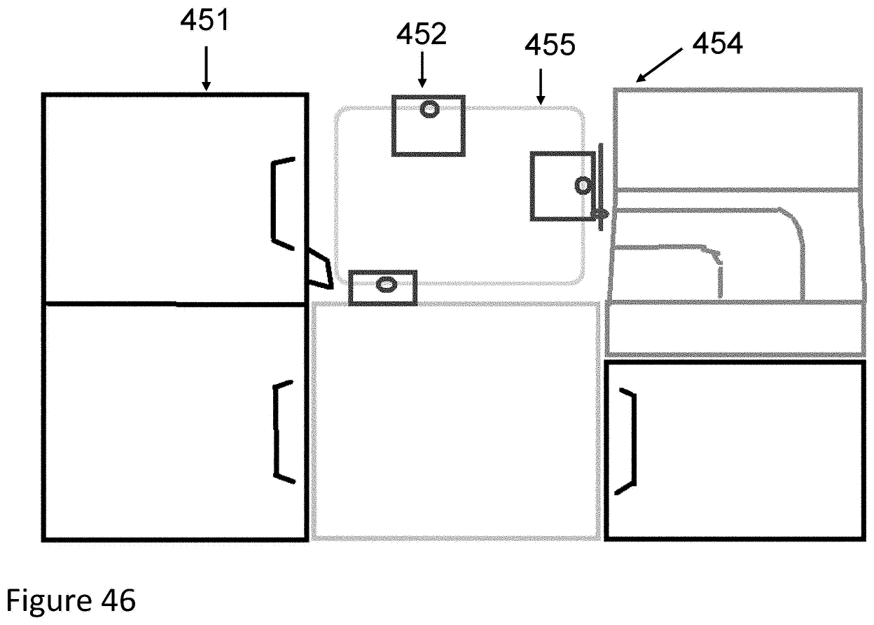

FIG. 45 shows a diagram illustrating a continuous system. The refrigerator 451 (or freezer chamber) dispenses product straight into little baskets 452. These are suspended onto belts 453 and travel slowly into the wells 454 (the fryer is custom made). Once the basket is out some actuator is flicking it and the product dispense into the hot holding. The first well towards the user is for manual in/out the other two wells towards the wall are automated and covered by a glass partition. The unit may be 2-2.5 m wide but the depth will be small. No sliding units and basket passing, very few motors. FIG. 46 shows a diagram illustrating another continuous system. A stainless-steel conveyor 455 could also be used to transport product (such as double layered transport mechanism to ensure product travel and submersion).

The system can provide specific data regarding system performance. The data can be used for several reasons such as ensuring that the system is aligned with operational schedules, minimize downtime, optimize energy usage, prevent damage or inefficiencies, as well as enhance overall system reliability, longevity, maintenance planning and overall product quality. Specific data that can be monitored or tracked in real-time include data related to the following behavior or parameter:
‘Time turned on’: this data allows to assess whether the system is being activated at the appropriate time, such as in the morning. This can be used for maintenance purposes. Is the system being turned on at the right time in the morning? Used for example for maintenance.
‘Time turned off’ behavior’: this provides insights into the system's shutdown process. Is the system being turned off and is it being shut down in the correct way? Used for example for maintenance.
‘E-stop/shutdown’ behavior’: this data provides insights into potential safety hazards or malfunctions within the system, enabling proactive maintenance to address root cause and prevent accidents. Additionally, tracking ‘off and on again’ actions help identify recurring issues. This data aids engineer in diagnosing and rectifying underlying problems.
‘Time the freezer door is open’: If freezer door is left open for more than x seconds, the system should alert the user. If the freezer door is left open for more than y seconds, it should probably switch off to reduce wear. A freezer door sensor may therefore be used.
‘Time freezer taken to cool’: this data is useful to monitor that the freezer is performing correctly, and to assess the efficiency and reliability of the cooling system. By tracking how long it takes the freezer to reach a desired temperature, the system can identify any deviations form expected cooling times and identify any potential issues. This also helps in preventing spoilage of the stored items. This duration is also dynamically provided to operating staff, so they know how long to wait roughly.
‘Freezer refill quantity’: this data provides insight on user/operator behaviour and consumption patterns. By monitoring this data, the system can gain insights into how users interact with the freezer, such as when the users refill the freezer and if they refill to the full amount, when it's empty, or when it's half full. By understanding refill pattern, the system can for example optimise restocking schedule, improve inventory management, indicate product demand cycle, indicate user preference. The system may use a weight scale to monitor this data.
‘Dispensing time vs dispense amount’: this data may be combined with other parameters such as hopper level and weight sensor readings to identify potential issues in the dispensing system such as product bridging. Some examples are provided:
   if dispenser ‘dispenses’ for more than x seconds and hopper level is ‘low’ a refill should be called. The system may use a level sensor, mass scale to monitor this data.
   if dispenser ‘dispenses’ for more than x seconds and hopper level is ‘normal’ and the weight sensor isn't reading expected amounts, this may indicate that something is wrong. This may be an indication of product bridging or another issue. Product bridging occurs when the dispensing material forms a bridge or blockage within the hopper or dispenser, preventing the expected amount from flowing freely. Hence in this case, operating staff can poke the product with an anti-bridging poking stick. Maintenance engineering team may use this data to diagnose a root cause of a problem and to ensure the dispenser operates efficiently. The system may use a weight cell to monitor this data.
‘Dispensing motor current’: this data can provide invaluable data to maintain the functionality and safety of the dispensing system. A high current draw from the dispensing motor may for example signify a jam or some other error within the system. In such cases, an immediate action may be required to ensure smooth operation. As an example, operating staff may release the jam with the anti-jam poking stick. The system may therefore incorporate overcurrent protection devices or mechanisms, such as fuses or circuit breakers.
‘Transport motor current’: a high current draw may signify a blockage or some other error within the system (broken limit/homing). Operating staff may reset the system, or an engineer may be called out. The system may therefore incorporate overcurrent protection devices or mechanisms, such as fuses or circuit breakers.
‘Motor/board temperatures’: this data can be used to indicate an error within the system and to ensure a proper longevity of the motor-driven part of the system. A fluctuation or abnormal temperatures in the motor or associated control board can be detected. Sensors, such as temperature sensors, can be deployed.
‘Transport time from freezer to oil’: this data can be monitored to assess product quality. As an example, the system may monitor how long frozen products are out of the freezer before frying.
‘Drain time’: this data is monitored to ensure that a product is being drained for long enough after frying, affecting both product quality and safety.
‘Transport time vs encoder information vs limits reached’: tracking the movement and behaviour of the transport system is used to detect issues or unusual behaviour. Does it reach its homing limits.
‘Freezer temperature over time’. This data is used to monitor the freezer's performance and identify potential problems, which can impact both product quality and safety. Operating staff can play a role in cleaning filters and coils as part of regular maintenance tasks. As an example, the system may provide an alert that the condenser filter might need changing, or the coils cleaning, or another issues. Appropriate sensors such as thermocouples, encoders, can be used to collect real-time data.
‘Number of times the doors are opened and closed’: monitoring this may help detect unusual behaviour and gauge wear on parts. A door sensor can be used to collect this data.
‘Transports distance travelled and transport cycles’: this data is monitored to predict wear on the machine for maintenance. Transport limit switches and encoder information can be used.
‘HMI interaction data (see also below)’: this data is helpful to understand user behaviours and monitor any unusual activity. This may then be used to improve the UX design.
‘System locks’: monitoring this helps to understand whether there is unusual behaviour in locking states. Multiple latch sensors may therefore be used.
‘Oil activity’: monitoring oil activity is helpful to understand if oil related prompts, such as filter changes or skimming procedures are being acknowledges and carried out promptly. As an example, if “oil activity” data shows a delay or lack or response to prompts, this can affect product quality and safety. This can further be used to assess staff training.
‘Product processed amount vs ordered amount’: comparing this metric helps determine the expected waste of product. This can help restaurant managers to make decisions to enhance cost-efficiency and sustainability while minimizing food waste.
‘Processed amount’, ‘total amount’ of product through the system also helps determine stock use.
‘Number of batches’: this is a valuable metric for account management and operational oversight.
‘Cycle times’ (basket processing time): monitoring cycle times is valuable for account management. It ensures billing accuracy and supports resource allocation.
‘Cycle times’ (basket processing time): monitoring cycle times also determines if an optimum performance is being hit, and helps understand throughput.
‘Maintenance logs’: monitoring maintenance logs determines current, outstanding, and past maintenance activities, including parts. It also enables to detect or track problems.
‘Connectivity’: when/how long the system is or isn't connected to the internet, to determine connectivity health.

HMI metrics are key performance indicators used to assess usability, performance, and effectiveness of user interfaces. It can be used to evaluable user experience and optimise the UX design and functionality. These metrics are also invaluable for maintenance staff and restaurant managers. These metrics can be automatically tracked by the system or can also be observationally quantified if required. Examples of HMI metrics monitors are now provided.

### HMI Metrics

Error acknowledgement time and error rectification time: this metric helps to determine whether the UX is effective in communicating to the user. This is also useful to determine how long an error has been unaddressed for.
Proactive behaviour: understand behaviour around refills, oil management, packaging—whether people wait for an alert or whether they proactively do these things.
Alert acknowledgement time and action time: this metric determines time taken to respond to the system requests such as refill alerts, oil management alerts, or hot hold alters.
Time taken to perform task: this metric helps to determine how long tasks such as refills take to understand usability.

### Overall/Product Lifecycle

Understand improvements between prototypes/products. Key metrics monitored may include: temperature monitoring accuracy, dispense accuracy, throughput.

### Improved Key Features

We now provide a list of improved key features (A1-I1). Each Feature (A1-I1) and each optional feature can be combined with any other Feature described below and herein and any other optional feature. Each feature can also be combined with any other Feature and any optional features as defined in Appendix A (see Features A-W). Other aspects are a meal prepared using the device or system defined in any Features below and in Appendix A and any related optional feature(s), as well as a restaurant, kitchen or dark kitchen including the device or system defined in any Features below and in Appendix A and in any related optional feature(s).
Feature A1—Freezer chamber comprises a twin auger subsystem

An automated food-fryer system that is configured to move a basket from a position at which it can receive food from a frozen food dispenser to a cooking well; in which the system includes a freezer chamber that includes a twin auger subsystem that is configured to dispense food into the frozen food dispenser.
Feature B1—Freezer chamber is entirely removable from the system

An automated food-fryer system that is configured to move a basket from a position at which it can receive food from a frozen food dispenser to a cooking well; in which the system includes a freezer chamber that is configured to dispense food into the frozen food dispenser; and in which the freezer chamber is entirely removable from the other parts of the system.
Feature C1—Basket transport system includes a main transport subsystem that moves the basket laterally across the system and multiple vertical transport subsystems that moves the basket vertically across the system between the main transport subsystem and cooking wells

An automated food-fryer system that is configured to move a basket from a position at which it can receive food from a frozen food dispenser to a cooking well; the system including a basket transport system that is made up of (i) a main transport subsystem that moves the basket laterally across the system and (ii) multiple vertical transport subsystems that moves the basket vertically across the system between the main transport subsystem.
Feature D1—Transport module includes a basket shaker mechanism that shakes the basket while it is being transported up and down from the vertical transport subsystem

An automated food-fryer system that is configured to move a basket from a position at which it can receive food from a frozen food dispenser to a cooking well; the system including a vertical transport subsystem that includes a basket shaker mechanism that shakes the basket while the basket is being transported.
Feature E1—Hot Hold zone

An automated food-fryer system that is configured to move a basket from a position at which it can receive food from a frozen food dispenser to a cooking well and then to hot hold zone; in which the system is configured to adjust the temperature of the hot hold zone to a predefined temperature.
Feature F1—System auto adapts to variation in products and/or to new product or ingredient being introduced

As an example, the system can automatically set the oil temperature in a well depending on a product being cooked. The system can detect a product, such as chicken vs. fries and adjust the oil temperature or another setting accordingly, such as holding temperature, batch size, cook time, hold time, or oil temperature. Multiple products may include for example any one or more of the following: nuggets, sweet potatoes, wedges, fries.

An automated food-fryer system that is configured to move a basket from a position at which it can receive food from a frozen food dispenser to a cooking well; in which the system is configured to automatically adapt to variation in products and/or to new product or ingredient introduced.
Feature G1—Oil condition measurement subsystem is provided for each well.

An automated food-fryer system that is configured to move a basket from a position at which it can receive food from a frozen food dispenser to a cooking well; in which the system includes an oil measurement subsystem that is configured to monitor oil related parameter in the cooking well.
Feature H1—System includes segregated fryers or baskets for dietary requirements or allergens.

An automated food-fryer system that is configured to move baskets from a position at which it can receive food from a frozen food dispenser to cooking wells; in which the system includes segregated cooking wells or baskets for dietary requirements or allergens.
Feature I1—A remote management system that organises multiple food fryer systems

A remote management system that organises multiple food fryer systems at different locations, in which each food fryer system is an automated food-fryer system that is configured to move baskets from a position at which it can receive food from a frozen food dispenser to cooking wells.

### Generally Applicable Optional Features

### Twin Auger Subsystem

The twin auger subsystem is configured to shear or separate block(s) of frozen food into individual or smaller portion of frozen food items.
The twin auger subsystem includes two augers that are configured to freely rotate within the freezer chamber.
The twin auger subsystem further includes a drive mechanism that is configured to rotate the first auger and the second auger either simultaneously or independently.
The drive mechanism is configured to adjust rotational speed and/or direction of the first auger and/or second auger to optimise the processing of a food type.
The driving mechanism (including the motor(s)) is positioned outside the freezer chamber.
The augers have opposing tines moving together to minimise food jamming.
Each auger is shaped with a slope, in which the slope is shaped to tailor to the food to be processed.
The slope of the taper varies along the length of the auger to optimize the processing of different food types.
Frozen food is frozen fries, and the twin auger subsystem is configured to separate the frozen fries into individual fries.
Each augur is positioned over a curved channel, running parallel to the augur.
The twin auger subsystem delivers food into the frozen food dispenser that is mounted on a load cell, in which the load cell feeds a control circuit that controls the drive mechanism.
The frozen food dispenser and load cell, as well as the freezer chamber, are part of a cold unit.
Frozen food is one or more of potato, potato chips, vegetable chips, hash browns, chicken nuggets, chicken wings, mars bars, doughnut or any other fried food.
The system is configured to track the quantity of frozen food inside the freezer chamber, the frozen food dispense time and/or the mass of frozen food dispensed.
Baskets are capable of storing a multiple of products. For example, hash browns (e.g. in little wire baskets with spacers between them) can be stacked and picked or dropped into a standard fry basket for cooking, thus eliminating the need for a special basket for hash browns.

### Freezer Chamber

Freezer chamber is mounted on rails.
System includes a closed loop air recirculation subsystem.
Freezer chamber includes a crumb tray that collects crumbs and/or small pieces of food product to prevent them from going into the basket.
System includes an agitation subsystem that is configured to dislodge crumbs and/or small pieces small of food product so that they are collected in the crumb tray.
Freezer chamber includes a “de-clumping” subsystem that is configured to break-up or separate clumps of frozen product prior to be dispensed into a frozen food dispenser.
Freezer chamber unlocks and opens using a button, such as a foot pedal or foot-operated button.
Freezer chamber includes swappable freezer hoppers and/or swappable drawers.
Freezer chamber includes a drawer that is not protruding into walkways.
Drawer includes a lift flap or similar.
Drawer includes the twin auger subsystem.
Drawer stores two different food product, in which each product is stored in a different zone, each zone having an auger. As an example, 2 different products with a single auger (occupying half the volume each) with central separator. Still with a single timing hopper so the output stage is the same. In this configuration, the drawer would need to be coupled with a split hot hold chute.
Freezer chamber includes multiple freezer unit, such as different sized freezer units to facilitate different food type. For example, the freezer chamber may facilitate a primary product and a secondary product. This is useful as all customers don't have a 50-50 split between their top two open fryer products.

### Frozen Food Dispenser

The frozen food dispenser includes bomber-style doors that pivot open.
A sliding insulated cold chamber door is located under the bomber-style doors and is configured to open before the bomber-style doors open.
The frozen food dispenser is configured to dispense frozen food directly into the basket sitting under the opening made by the bomber-style doors.
The frozen food dispenser has a sensor on a door that seals the cold chamber to confirm that the door has sealed properly (e.g. and no chips are stuck there preventing the door from closing and hence letting warm air into the cold chamber).
The sensor gives telemetry signal to enable rapid fault finding if the door is not closing properly.

### Basket Transport System

Multiple vertical transport subsystem is also configured to move the basket to and away from a frozen food dispenser and/or to and away from the food dump.
The system includes multiple frozen food dispensers and the basket transport system is configured to move the basket to a position at which it can receive food from a specific frozen food dispenser.
There are multiple frozen food dispensers, and the dispenser transport module is configured to move the basket under a specific food dispenser.
The main transport subsystem is a linear transport subsystem that enables the basket to be moved solely in the horizontal direction.

### Basket Shaker

The basket is attached to a holder that moves up and down along the vertical transport subsystem.
The holder is configured to pivot upwards and downwards to cause the basket to also pivot upwards and then downwards, giving the basket contents a shake. Shaking the basket removes excess oil from fried food in the basket.
The vertical transport subsystem includes a profiled feature such that when the holder rides up over the profiled feature, the holder is pivoted upwards and downwards.
The vertical transport subsystem includes several profiled features such that the holder can ride up over several profiled features, in each case giving the basket a shake.

### Basket Gripper

A basket gripper is configured to grip the basket.
The basket includes a hook that is configured to engage onto the basket gripper.
The basket gripper includes a horizontal channel into which the horizontal bar of the hook on the standard fryer basket engages.
The basket hook is secured by the gripper with (a) a horizontal channel into which the horizontal bar engages to centre and align the gripper and (b) left and right sides, each with channels into which the left and right side inverted U-shaped side bars engage; the left and right sides of the gripper configured to open around the side bars and to close against those side bars.

### Basket Belt With Basket Gripper

The vertical transport subsystem includes a basket belt that lowers the fryer basket between the main transport working height and the frozen dispenser outlet heigh includes a basket gripper.
The basket gripper includes a horizontal channel into which the horizontal bar of the hook on the standard fryer basket engages.
The basket belt is removable from its drive mechanism for cleaning.

### Hot Hold Zone

The holt hold zone includes a removable fried food or hot hold container or tub that is designed to sit on a load cell sensor integrated into a large plate or landing surface.
A heat lamp above the hot hold zone maintains the temperature in the hot hold zone at a predefined temperature, such as approximately 65 C.
The temperature is regulated by a thermocouple and a closed loop feedback circuit.
A hot air recirculation system is used to maintain the temperature in the hot hold zone.
Freezer condensing coils preheat the air for the hot hold zone.
The system connects to individual hot-hold cabinets, so that end-users can collect fried food directly.
The hot hold zone is configured to hold multiple products into different sub-area, in which each sub-area has requirements, such as temperature, specific to the product it is holding. This is useful when hot holding a variety of products. For example, hot holding for hash browns and chicken pieces may have different requirements than hot holding for fries.

### Improved Process

System includes multiple cooking wells and an oil measurement subsystem is provided for each well.
Oil measurement subsystem includes an oil quality sensor.
Oil related parameters include one or more of the following: quality, temperature, contamination, colour, capacitance. Multiple sensors may be used such as ultrasonic, laser or vision sensor.
Oil measurement subsystem is directly integrated to the food fryer system.
Oil related parameters are derived from emitted gas analysis (i.e. particular inspection of the rising air, or “smell analysis”).
System includes a central oil reservoir that is connected to each well.
System is connected to oil tank(s) for non-human top ups.
System is configured to support on the go oil changes so that the system never stops working.
Each well includes a submerged/detached basket agitator.
System is configured to detect or sense when the fryer fails to set a parameter properly such as hold temperature or oil temperature.
System is configured to automatically reject food that has not been or is not being cooked properly and does not mix with other properly cooked product—i.e. reject undercooked or not properly cooked product.
System is configured to detect or analyse a cooking profile by comparing the weight of the frozen food to the eight of the corresponding cooked food.
System includes a seasoner unit that automatically seasons cooked food with multiple seasoning.
System includes a holder for a seasoner.
Seasoning control subsystem configured to season cooked food according to seasoning parameters, in which the seasoning parameters may include one or more of the following: plain, level of saltiness, level of spiciness, salsa.
Seasoning parameters are user configured or automatically adjusted depending on specific requirements.
System can provide one or more additional cook cycles—e.g. double or triple cooked chips.
System provides texture control, such as soft, medium, crispy. This may be provided to target specific customer such as different age groups. A customer can select the texture parameter on a user interface.
System includes a quality control subsystem configured to automatically estimate the quality of a final product. The quality control subsystem implements a statistical process control of quality based on automatic sample measurements of a number of parameters, such as texture (crispiness), colour, flavour, smell, or structural integrity.
System includes a computer vision subsystem configured to detect cleanliness of the food fryer system.
System is configured to automatically clean and/or to detect when the system requires a clean or needs maintenance.
System automatically outputs an alert to schedule a future clean or maintenance.
System is configured to automatically detect food that is stuck in the basket. This may be implemented via a computer vision subsystem.
System provides automatic skimming. This may be driven by a computer vision subsystem.

### Allergen

Basket and/or cooking well segregation is provided per product, e.g. for vegan, allergen, contamination, etc.

### Dispensing Functionality

Multi-stage processes before dispense. E.g. dispense fish, batter fish, fry fish.
System includes a peeling subsystem that is configured to automatically peel food, such as potato.
System includes a cutting subsystem that is configured to automatically cut the food into desired portions.
System includes a bag opening subsystem that is configured to automatically open a bag of food.
System includes a bin for discarding empty bags.
System includes a computer vision subsystem that is configured to detect bad product and/or incorrect product (both at dispense and on cook finish).
System includes a food dump with multiple sub-areas corresponding to different product or different seasoning or different cooking profiles. For example the system may include a split chip dump for salted/unsalted fries.

### Packing/Packaging Functionality

System is configured to automatically pack the cooked product.
System provides support for reusable packaging.
System provides personalisation of packaging, e.g. by name of guest, items contents, content weight/calories.
System is able to pack or portion a complete meal.

### Remote Management System

The remote management system organises the multiple food fryer systems at different restaurants in logical groups.
The remote management system includes a visualisation module that generates visual representation of restaurant performance data for each logical group.
The remote management system is configured to share cooking parameters and recipes among the multiple food fryer systems within a logical group.
The remote management system includes a user interface for managing the logical groups and accessing the visualisation data.

### Remote Monitoring/Configuration

System communicates with a communication module that transmits cooking parameter data to the system.
Communication module is able to transmit cooking parameter data to multiple food fryer systems at different locations.
Communication module also remotely monitors the operation of the multiple food fryer systems, detects error conditions in the operation of the multiple food fryer systems and transmits error notifications in response to the detected error conditions.
Cooking parameter data includes temperature setting, cooking time setting and cooking mode settings.
System includes a memory subsystem for storing cooking parameter data.
System is configured to automatically schedule maintenance of the system, such as replacement of degraded parts, based on an analysis of telemetry data or based on performance metrics of the system.
System is configured to automatically schedule remote software upgrades.
System includes a remote control.
System includes a machine vision subsystem configured to control, locate and monitor basket(s)and assess the business of a store or drive through to initiate a cook.

### Additional Functionality

System includes guards and is configured to duct guards in order to create a sealed connection with an extract system in order to extract power.
System includes 48 Volts electronics, such as one or more stepper motors powered by 48V. This enables the system to achieve a desired accuracy.
Machine with built in fryers. This may facilitate certain tasks such as oil skimming. This is also advantageous for new sites or customers that don't yet have fryers. It could also reduce the footprint of the machine and allow different configurations.
Support for other types of fryer beyond open basket. E.g. Pressure fryer or air fryer.
Additional integrations are provided in FIG. 44.
A continuous fryer as shown in FIGS. 45-46. The refrigerator dispenses product strait into little baskets. These are suspended onto belts and travel slowly into the wells (the fryer is custom made). Once the basket is out some actuator is flicking it and the product dispense into the hot holding. The first well towards the user is for manual in/out the other two wells towards the wall are automated and covered by a glass partition. The unit may be 2-2.5 m wide but the depth will be small. No sliding units and basket passing, very few motors. A stainless steel conveyor could also be used to transport product (such as double layered transport mechanism to ensure product travel and submersion).

### User Interface (UI)

System includes a user interface that enables an end-user to configure the food fryer system and/or to select configuration parameters.
UI displays configuration parameters of the system, such as “cook to rate” that allows a user to set the desired cooking rate for the system.
UI displays number or parameters associated with available fry positions.
UI displays ordering information for multiple baskets to determine the order of cooking.
UI enables a user to select different parameters for cooking sequence and/or basket allocation.
UI enables the monitoring of space availability in the system, such as freezer chamber or frozen food dispenser.
Percentage of space available (or inversely of the space already taken) in a freezer chamber or frozen food dispenser is displayed. For example, the percentage may be displayed according to a list of five different levels: 0%, 25%, 50%, 75%, 100%.
UI supports personalisation based on language and/or region localization.
UI enables a user to select and/or initiate over-the-air (OTA) upgrades.

1-166. (canceled)

167. An automated cooking system, comprising:
a fryer including at least one fryer vat configured to hold a cooking medium;
at least one basket configured to receive and hold a food product for cooking in the cooking medium at the fryer;
a frozen food dispenser positioned proximate to the fryer;
a hot holding station positioned proximate to the fryer; and
a basket transportation system configured to transport the basket between the frozen food dispenser, the at least one fryer vat, and the hot holding station,
wherein the frozen food dispenser and the hot holding station are arranged to share a footprint space, such that a combination of a footprint space of the frozen food dispenser and a footprint space of the hot holding station is less than or equal to the footprint space of the frozen food dispenser or the footprint space of the hot holding station.

168. The automated cooking system of claim 167, wherein the hot holding station is arranged above the frozen food dispenser.

169. The automated cooking system of claim 168, wherein the hot holding station is arranged substantially on top of the frozen food dispenser.

170. The automated cooking system of claim 167, wherein a waste heat from the frozen food dispenser is provided to the hot holding station.

171. The automated cooking system of claim 170, wherein the frozen food dispenser includes a freezer, and wherein the freezer provides the waste heat.

172. The automated cooking system of claim 171, wherein the freezer includes at least one condensing coil, and wherein the at least one condensing coil generates the waste heat.

173. The automated cooking system of claim 170, wherein the waste heat preheats an air in the hot holding station.

174. An automated cooking system, comprising:
a fryer including at least one fryer vat configured to hold a cooking medium;
at least one basket configured to receive and hold a food product for cooking in the cooking medium at the fryer;
a frozen food dispenser positioned proximate to the fryer, the frozen food dispenser comprising:
a freezer; and
an auger system configured to shear or separate block(s) of the food product into individual or smaller portions of the food product and configured to deliver the food product from the freezer to the frozen food dispenser;
a hot holding station positioned proximate to the fryer; and
a basket transportation system configured to transport the basket between the frozen food dispenser, the at least one fryer vat, and the hot holding station.

175. The automated cooking system of claim 174, wherein the auger system includes at least one auger shaped with a slope selected based upon the food product to be dispensed by the auger system.

176. The automated cooking system of claim 175, wherein the slope of the at least one auger varies along a length of the auger such that the at least one auger is the optimized to dispense a number of different food products.

177. The automated cooking system of claim 175, wherein the at least one auger is positioned over a curved channel running parallel to the at least one auger.

178. The automated cooking system of claim 174, wherein the auger system includes at least one auger, the at least one auger configured to rotate freely within the freezer.

179. The automated cooking system of claim 178, wherein the auger system further comprises a drive mechanism configured to rotate the at least one auger.

180. The automated cooking system of claim 179, wherein the frozen food dispenser is mounted on a load cell, and wherein the load cell feeds a control circuit that controls the drive mechanism.

181. The automated cooking system of claim 179, wherein the drive mechanism is positioned outside of the freezer.

182. The automated cooking system of claim 179, wherein the at least one auger includes a first auger and a second auger, and wherein the drive mechanism is configured to adjust a rotational speed and/or direction of the first auger and/or the second auger to optimize the processing of the food product.

183. The automated cooking system of claim 179, wherein the at least one auger includes a first auger and a second auger, and wherein the drive mechanism is configured to rotate the first auger and the second auger independently.

184. The automated cooking system of claim 179, wherein the at least one auger includes a first auger and a second auger, and wherein the drive mechanism is configured to rotate the first auger and the second auger simultaneously.

185. The automated cooking system of claim 184, wherein the first auger and the second auger have opposing tines moving together to minimize food jamming.

186. The automated cooking system of claim 174, wherein the food product is selected from the group consisting of frozen fries, potato, potato chips, vegetable chips, hash browns, chicken nuggets, chicken wings, mars bars, and doughnuts.

187. The automated cooking system of claim 186, wherein the food product is frozen fries, and wherein the auger system is configured to separate the frozen fries into individual fries.

188. The automated cooking system of claim 174, wherein the automated cooking system is configured to track a quantity of food product inside the freezer, a food product dispense time, and/or a mass of food product dispensed.
